(19) United States
(12) Patent Application Publication
(10) Pub. No.: US 2014/0318657 A1
(43) Pub. Date: Oct. 30, 2014

(54) FLUID CONVEYING APPARATUS WITH LOW DRAG, ANTI-FOULING FLOW SURFACE AND METHODS OF MAKING SAME

(71) Applicant: THE OHIO STATE UNIVERSITY, Columbus, OH (US)

(72) Inventors: Gregory D. Bixler, Blacklick, OH (US); Bharat Bhushan, Powell, OH (US)

(73) Assignee: The Ohio State University, Columbus, OH (US)

(21) Appl. No.: 13/874,082

(22) Filed: Apr. 30, 2013

(51) Int. Cl. F15D 1/00

(52) U.S. Cl. CPC F15D 1/003; F15D 1/0085
USPC 138/39; 156/293; 264/241

(57) ABSTRACT

A fluid conveying apparatus including a wall structure forming a channel for conveying fluid. The channel is bounded by an interior face of the wall structure. A rice leaf-like textured surface is formed on the interior face. The textured surface includes a plurality of micropillars projecting from the interior face and arranged in a geometry akin to rice leaf micropapillae. In some embodiments, the textured surface is a replica of a rice leaf hierarchical structure. In other embodiments, the micropillars are arranged to define a plurality of longitudinal grooves having a transverse sinusoidal pattern. The micropillars can are arranged in a substantially uniform micropattern, and have a diameter of about 2 μm, a height of about 4 μm, and a pitch distance of about 4 μm. A nanostructured coating can assist in rendering the micropillars superhydrophobic, and mimics the waxy nanobumps of a native rice leaf.

### STATEMENT REGARDING FEDERALLY FUNDED RESEARCH OR DEVELOPMENT

This invention was made with government support from the National Science Foundation, Grant Number CMMI-1000108. The government has certain rights in the invention.

### BACKGROUND

The present disclosure relates to fluid conveying apparatuses forming a channel through or along which fluid is conveyed, such as tubes, pipes, etc. More particularly, it relates to fluid conveying apparatuses with channel flow surfaces presenting minimal drag properties.

Tubes, pipes and a plethora of other channel-defining structures are commonly employed to convey or transfer fluid in a wide range of vastly different environments. For example, flexible, small diameter catheters are used to convey small volumes of medical liquids (e.g., blood), whereas rigid, large diameter pipes convey large volumes of other liquids such as water or oil. In these and many other end use applications, the particular channel-defining structure is conventionally designed to present as flat (smooth) a surface as possible to fluid flowing through the channel, under the assumption that a flat surface will generate minimal drag. As a point of reference, drag is the resistant force a fluid imposes on an object in either closed channel (internal flow) or open channel (external flow) conditions; the surface of the object along which the fluid flows directly affects drag (via skin friction).

More recently, efforts have been made, in the context of open channel flow, to design surfaces with reduced drag properties. Inspired by designs found throughout living nature, researchers have investigated some of the world's flora and fauna to solve fluid drag and other technical challenges. Examples include “low drag” surfaces of boats and swimsuits inspired by low drag shark skin. Also, “self-cleaning” windows inspired by the superhydrophobic and low adhesion lotus leaf have been devised. Self-cleaning occurs when contaminant particles are collected and removed from a surface by fluid flow.

Another, but not yet fully resolved, technological problem common place to fluid flow applications is fouling. Fouling can be generally categorized as biological fouling (“biofouling”) or inorganic fouling. Biofouling is the accumulation of unwanted biological matter, with biofilms created by microorganisms and macroscale biofouling created by macroorganisms. In addition to biofouling, inorganic fouling can occur as a result of deposits from corrosion, crystallization, suspended particles, oil, ice, etc. Furthermore, biologically induced corrosion is of concern. A low drag surface often equates to less fouling and energy conservation, which is important for many industries.

Many engineering applications can benefit from low drag and self-cleaning surfaces in the medical, marine, and industrial fields. As but one example, low drag is important for the oil transportation industry, where pipeline flow must overcome high drag (with Reynolds numbers reaching 1×10⁵). Lower drag in pipelines reduces the required pumping energy and increases flow rates, which saves both time and money. Traditionally, drag is lowered using fluid additives or improving the pipeline interior smoothness with corrosion resistant epoxy coatings. By way of further example, self-cleaning can also be an important characteristic with oil transportation (and other) applications for preventing the unwanted deposition of oil by means of oil-resistant or superoleophobic properties.

As mentioned above, characteristics of certain flora and fauna have previously been found beneficial for, and incorporated into, various products. In the aquatic environment, fish (for example rainbow trout) exhibit low drag in water. It is surmised that their surface is covered with oriented scales that promote anisotropic flow from head to tail. Furthermore, the scales are mucous covered (lowering drag) and hinged (preventing motion in the opposite direction), which help navigate in fast moving currents. Fast swimming shark skin (for example Mako) also exhibits low drag in water. This is due to anisotropic flow characteristics of riblet microstructures aligned in the swimming direction as well as the control of vortices on the skin normally present in turbulent flow. The riblets lift and pin any vortices generated in the viscous layer. Lifting reduces the total shear stress since vortices contact just the small riblet tips, as opposed to the total surface area. Pinning reduces the cross-stream motion of a fluid and ejection of vortices from the viscous sublayer, which reduces energy loss. Lower drag increases fluid flow at the skin, reduces microorganism settlement time, promotes washing, and allows for faster predatory swimming.

In the ambient environment, lotus leaves (Nelumbo mucifera) have been found to promote self-cleaning with a superhydrophobic and low adhesion surface, due to a waxy hierarchical surface structure. It has been found that key features of the lotus leaf are a microscopically rough surface, consisting of a vast array of randomly distributed micropapillae (diameters on the order of 5-10 μm) that are covered with the waxy, branch-like nanostructures (average diameter on the order of about 125 nm). Water on these surfaces can form almost spherical droplets that do not adhere to the surface. On an incline, the water droplets move easily, collecting and removing contaminant particles. These characteristics have been collectively referred to as the lotus effect. As a point of reference, “superhydrophobic” is in reference to surfaces that have a water contact angle of at least about 150°; the lotus leaf surface structure can provide contact angles as high as 170°.

While many attempts have been made to implement shark skin or lotus effects onto or into the surfaces of various articles intended to interface with liquids in an open-channel manner, only limited research has been previously made into possible closed channel end use applications. Moreover, many other items in living nature, previously not fully understood, may implicate further advancements in one or more of fluid drag, self-cleaning, or anti-fouling. Therefore, a need exists for fluid conveying apparatuses presenting a fluid interface surface that builds upon the shark skin and lotus effects, and methods of manufacturing the same.

### SUMMARY

Some aspects of the present disclosure relate to a fluid conveying apparatus. The apparatus includes a wall structure forming a channel for conveying fluid. The channel is bounded by an interior face of the wall structure. A rice leaf-like textured surface is formed on the interior face. The textured surface includes a plurality of micropillars projecting from the interior face and arranged in a geometry akin to rice leaf micropapillae. In some embodiments, the textured surface is a replica of a rice leaf surface structure. In other embodiments, the micropillars are arranged to define a plurality of longitudinal grooves having a transverse sinusoidal pattern. In yet other embodiments, the micropillars are arranged in a substantially uniform micropattern, and have a diameter on the order of about 2 μm and a height on the order of about 4 μm. In related embodiments, the micropillars are arranged into longitudinal rows having a pitch distance on the order of 4 μm. In even further related embodiments, the rows of micropillars are further grouped into sets of rows (e.g., three rows per set), and a lateral spacing on the order of 8 μm is established between adjacent sets.

The rice leaf-like textured surfaces of the present disclosure can further include a nanostructured coating applied to each of the micropillars, creating a hierarchical structure. The nanostructured coating can assist in rendering the micropillars superhydrophobic in some embodiments, and mimics the waxy nanobumps of a native rice leaf. In other embodiments, the nanostructured coating is superoleophobic.

The hierarchical, rice leaf-like textured surfaces are uniquely configured to exhibit low drag, self-cleaning, and anti-fouling properties. It has surprisingly been found that the textured surfaces of the present disclosure are highly useful in various fluid interface environments, for example closed channel flow environments. Various liquids, for example water, experience the lotus effect when traversing the textured surfaces of the present disclosure, with the textured surface further facilitating anti-fouling actions, unlike known flora or fauna-inspired fluid interface constructions. Further, other high viscosity liquids, such as oil, also experience very minimal drag when interfacing with the textured surfaces of the present disclosure in, for example, closed channel flow conditions. Thus, the fluid conveying apparatuses of the present disclosure are highly useful in a plethora of end-use applications, for example closed channel liquid flow devices ranging from small diameter catheters to large diameter oil pipelines.

Other aspects in accordance with principles of the present disclosure are directed toward methods of manufacturing an apparatus for conveying fluid. The method includes forming a textured surface on an interior face of a wall structure, with the interior face bounding a channel in the wall structure. The textured surface is rice leaf-like, and includes a plurality of micropillars projecting from the interior face and arranged in a geometry akin to rice leaf micropapillae. With this construction, fluid flowing through the channel experiences minimal drag along the textured surface. In some embodiments, the textured surface is formed by mold (e.g., master molds created using standard photolithography techniques and soft-lithography) replicating a native rice leaf. In other embodiments, the textured surface is formed on an adhesive-backed sheet formed apart from the wall structure. With these embodiments, the sheet is adhered to the interior face to locate the textured surface along the channel. In yet other embodiments, a nanostructured coating is applied to the micropillars, creating a hierarchical structure.

### BRIEF DESCRIPTION OF THE DRAWINGS

FIG. 1A is a simplified end view of a fluid conveying apparatus in accordance with principles of the present disclosure;

FIG. 1B is a simplified view of another fluid conveying apparatus in accordance with principles of the present disclosure;

FIG. 2 is a schematic illustration of a hierarchical textured surface in accordance with principles of the present disclosure and useful with the apparatus of FIGS. 1A and 1B;

FIG. 3A is a greatly enlarged, schematic illustration of a portion of one embodiment of a textured surface micropillar micropattern in accordance with principles of the present disclosure;

FIGS. 3B-3E are schematic illustrations of other textured surface micropillar micropatterns in accordance with principles of the present disclosure;

FIG. 3F is a schematic illustration of another textured surface micropattern in accordance with principles of the present disclosure;

FIG. 4A is a simplified side view illustrating water droplet interface with a rice leaf-like hierarchical structure in a tilted arrangement;

FIG. 4B is an end view of the interface of FIG. 4A in a horizontal arrangement;

FIG. 4C is a top view of the interface of FIG. 4B;

FIG. 4D is an enlarged view of a portion of FIG. 4C;

FIG. 4E is an enlarged, schematic illustration of the interface of FIG. 4B;

FIG. 5A is a schematic illustration of another textured surface micropillar micropattern in accordance with principles of the present disclosure;

FIG. 5B schematically illustrates interface of oil with textured surfaces of the present disclosure;

FIG. 6A is a schematic model of a velocity profile of oil flow along a flat surface closed channel;

FIG. 6B is a schematic model of a velocity profile of oil flow along a closed channel incorporating the rice leaf-like textured surfaces of the present disclosure;

FIG. 7 illustrates a method of manufacturing a rice leaf-like textured surface in accordance with principles of the present disclosure;

FIG. 8 is a schematic illustration of a closed channel device utilized with various tests of the present disclosure;

FIG. 9 is a schematic illustration of a pressure drop measuring system useful for measuring pressure drop along a closed channel with water, oil and air flow;

FIG. 10A is a schematic illustration of a contamination system useful for performing self-cleaning testing of textured surfaces of the present disclosure;

FIG. 10B is a schematic illustration of a wash experimentation system useful for performing self-cleaning testing of textured surfaces of the present disclosure;

FIG. 11 is a schematic illustration of a system for measuring the apparent contact angle of oil with a surface;

FIG. 12A provides digital photographs and SEM images of rice leaves, butterfly wings, fish scales and shark skin;

FIG. 12B provides optical profiler height maps of rice leaf, butterfly wing, fish scale and shark skin samples;

FIG. 12C provides optical profiler height maps of a flat surface uncoated, coated with a superhydrophobic coating, and coated with a superoleophobic coating;

FIG. 13A provides SEM images of replica rice leaf, butterfly wing, fish scale and shark skin samples;

FIG. 13B provides SEM images of a flat control sample, a replica rice leaf sample, and a replica shark skin sample before and after coating with either a superhydrophobic coating or a superoleophobic coating;

FIG. 14A provides graphical illustrations of pressure drop with low velocity water flow along various closed channel samples;

FIG. 14B provides graphical illustrations of pressure drop with high velocity water flow along various closed channel samples;

FIG. 15A provides graphical illustrations of pressure drop with low velocity oil flow along various closed channel samples;

FIG. 15B provides graphical illustrations of pressure drop with high velocity laminar oil flow along various closed channel samples;

FIG. 16A provides graphical illustrations of pressure drop with low velocity oil flow along various closed channel samples;

FIG. 16B provides graphical illustrations of pressure drop with high velocity laminar oil flow along various closed channel samples;

FIG. 17 provides graphical illustrations of pressure drop with low and high velocity air flow along various closed channel samples;

FIG. 18 provides a graphical illustration of nondimensional pressure drop values versus Reynolds numbers for various flat samples described in experiments of the present disclosure;

FIG. 19A provides SEM images of contaminated samples tested for self-cleaning;

FIG. 19B provides optical microscope images of various samples tested for self-cleaning, including before and after a washing test;

FIG. 20 provides a graphical illustration of the results of self-cleaning testing;

FIG. 21 provides water droplet images of various samples subjected to apparent contact angle testing;

FIG. 22A provides images and schematic models of oil droplet-water interface with native rice leaf, butterfly wing, fish scale and shark skin samples;

FIG. 22B provides a summary images of water droplet and oil droplet interfaces (in air and underwater) with replica rice leaf, butterfly wing, fish scale, and shark skin samples, and a flat surface sample;

FIG. 23A provides graphical illustrations of the results of apparent contact angle testing using actual and replica (uncoated and coated);

FIG. 23B provides graphical illustrations of the results of apparent contact angle hysteresis testing;

FIG. 24A provides images of oil droplet-water interface with laser etched riblet samples;

FIG. 24B provides graphical illustrations of the results of apparent contact angle testing at a solid-air-oil interface;

FIG. 24C provides graphical illustrations of the results of apparent contact angle testing at a solid-water-oil interface; and

FIG. 25 provides schematic models of water flow control mechanisms provided by rice leaves, butterfly wings, fish scales, and shark skin.

### DETAILED DESCRIPTION

In the present disclosure, “micro-scale” size is defined as a size in the range equal to or more than 1 μm and less than 100 μm. As used throughout the present disclosure, any term having the prefix “micro” is in reference to the micro-scale size unless stated otherwise. A “nano-scale” size is defined as a size in the range equal to or more than 1 nm and less than 1000 nm. As used throughout the present disclosure, any term having the prefix “nano” is in reference to the nano-scale size unless stated otherwise. A “hierarchical structure” or “hierarchical surface” comprises microstructures and nanostructures.

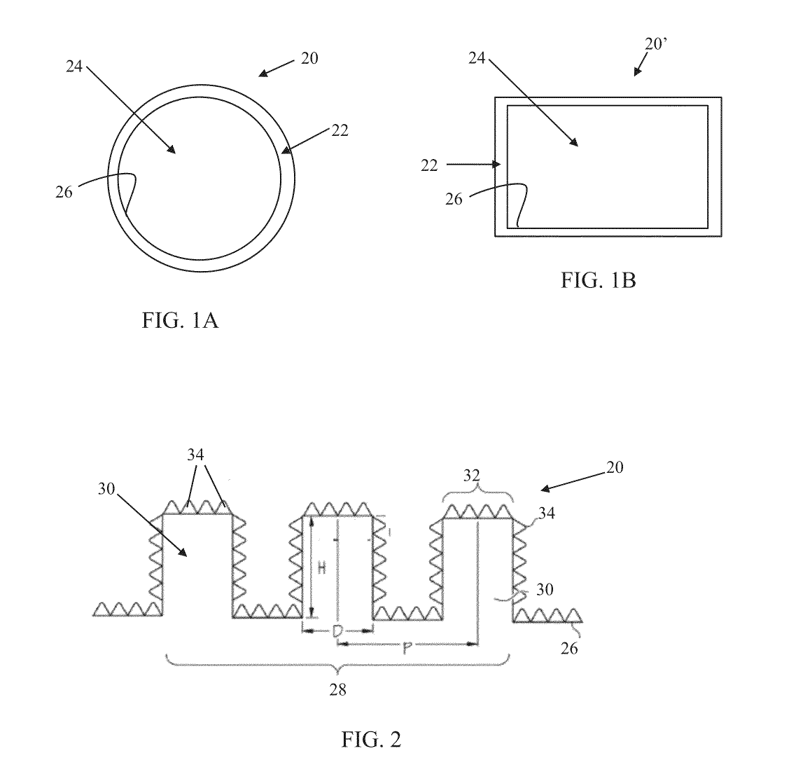

Aspects of the present disclosure are directed toward fluid conveying apparatuses having a fluid interface surface that incorporates a textured surface structure, in some embodiments a hierarchical textured surface, akin to a rice leaf as described in greater detail below. In more general terms, the fluid conveying apparatuses of the present disclosure can assume a multitude of different forms adapted for countless end-use applications. With this in mind, FIG. 1A illustrates one embodiment of a fluid conveying apparatus 20 in accordance with principles of the present disclosure and generally configured for closed channel fluid flow. The apparatus 20 is tubular, generally including a wall 22 that defines a channel 24 through (or along) the apparatus 20. The channel 24 is bounded by an interior face 26 of the wall 22. The apparatus 20 can be virtually any type of tubular body, ranging from a small diameter medical catheter or drug delivery tube to a large diameter pipe. Further, while the channel 24 is illustrated in FIG. 1A as being circular in cross-sectional shape, other shapes are equally acceptable, such as square, rectangular, irregular shaped, etc., as indicated, for example, by the alternative fluid conveying apparatus 20 of FIG. 1B. The wall 22 can be continuous, or can consist of two (or more) wall sections that are separately formed and subsequently assembled.

FIG. 2 schematically depicts a greatly magnified portion of the apparatus 20, and in particular a portion of the interior face 26. As shown, a textured surface or structure 28 (referenced generally) is formed or provided along the interior face 26, and in some embodiments is akin to or mimics the hierarchical surface structure of a rice leaf (Oryza sativa). As a point of reference, rice leaves are covered by a hierarchical surface structure consisting of micropapillae covered with epicuticular wax and that form a series of longitudinal grooves having a sinusoidal-like shape. It has surprisingly been found that the rice leaf hierarchical surface structure creates a superhydrophobic and low adhesion surface that directs water flow. It has further been surmised that because rice plants thrive in humid, marshy environments, this same hierarchical structure promotes self-cleaning to prevent unwanted biofouling that might otherwise inhibit photosynthesis. As described below, it has surprisingly been found that the rice leaf-like hierarchical textured surfaces of the present disclosure beneficially combine the shark skin and lotus effects.

The textured surface 28 mimics properties of the hierarchical surface of a rice leaf by including a plurality of micropillars (i.e., micro-scale sized pillars) 30 projecting from the interior face 26. In some embodiments, the textured surface 28 is a direct replica of the hierarchical surface of a rice leaf sample, with the replicated micropillars 30 being relatively randomly arranged in accordance with the micropapillae of the actual rice leaf sample being replicated. In other embodiments, the micropillars 30 are not directly molded from an actual rice leaf sample, and instead are formed and arranged in a micropatterned geometry described below. In either case, the micropillars 30 are generally cylindrical and are akin to the micropapillae (and corresponding micropattern) of rice leaves. The micropillars 30 can be rendered superhydrophobic with low adhesion via application of an optional nanostructured coating 32 that exhibits fluid interface properties akin to the epicuticular wax of rice leaves. The nanostructured coating 32 applies a plurality of nanoparticles 34 on each of the micropillars 30. In some embodiments, the nanoparticles 34 are silica particles, such as hydrophobosized silica nanoparticles, having a particle size on the order of 35-65 nm. In yet other embodiments, the rice leaf-like textured surfaces of the present disclosure consist of the micropillars 30 without the nanostructured coating 32, and thus are not necessarily hierarchical.

The micropillars 30 are, in some embodiments, substantially identical (e.g., dimensional parameters, such as diameter, do not vary by more than 10% across the micropillars 30). Each of the micropillars 30 can be substantially cylindrical, having or defining a height H and a diameter D. In some embodiments, the micropillars 30 have a substantially identical height H (e.g., variation in height H does not exceed 10% across the micropillars 30); in other embodiments, the micropillars 30 can have differing heights H.

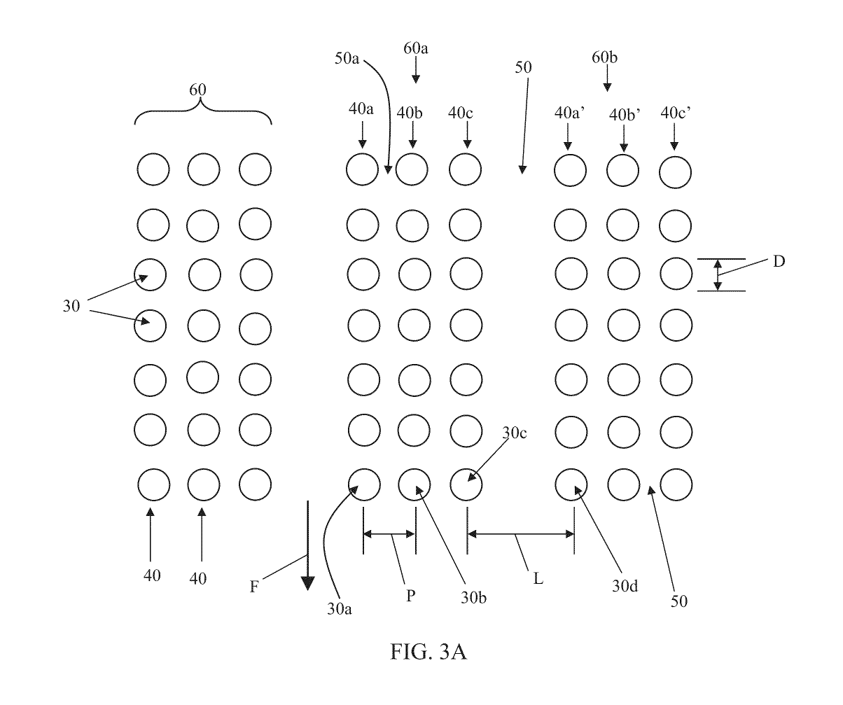

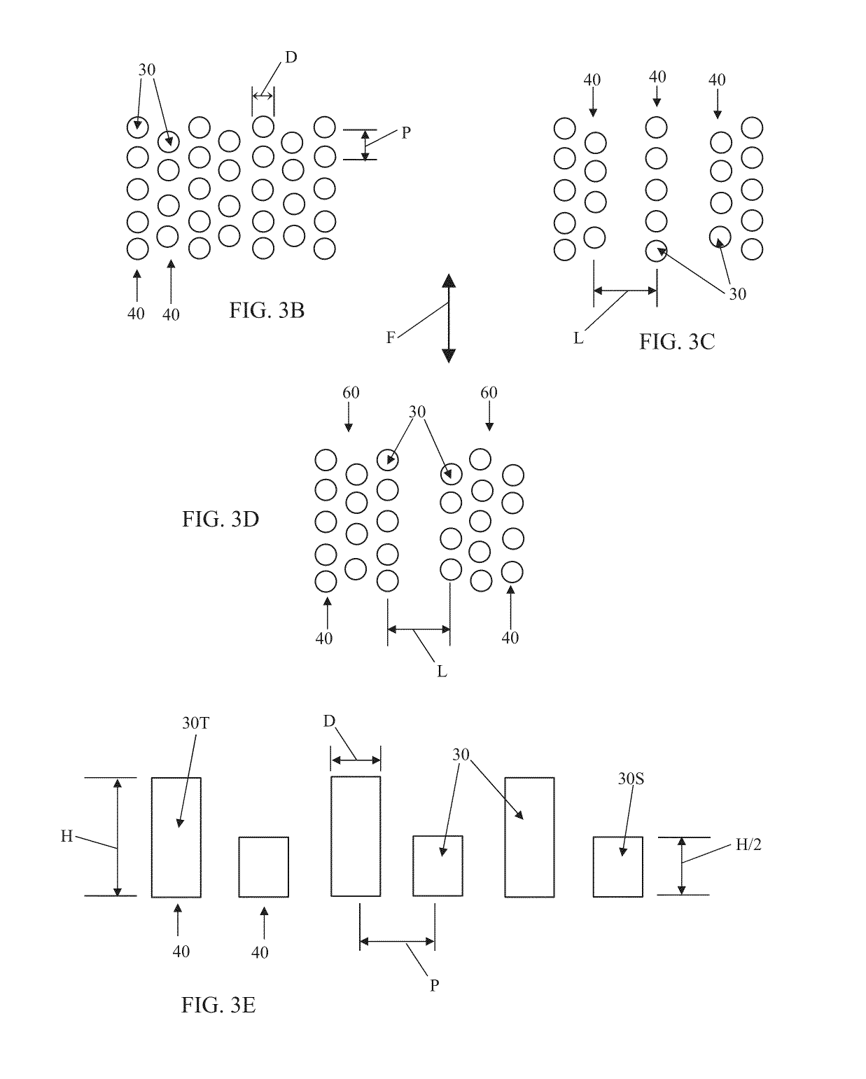

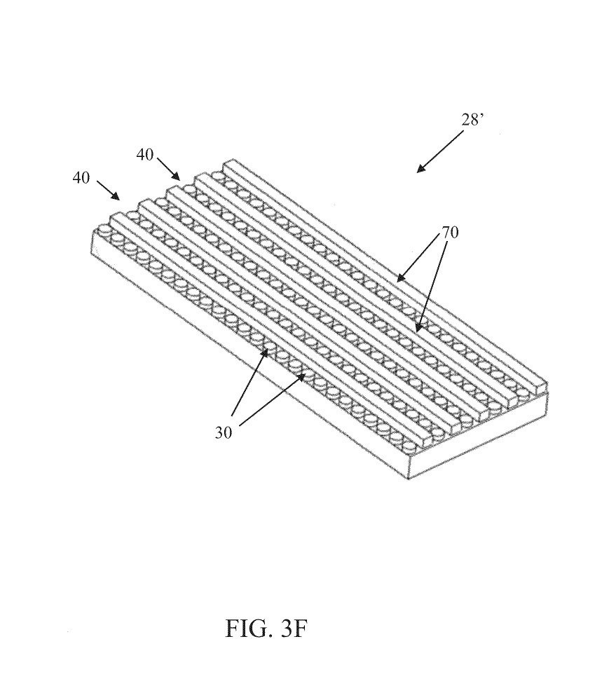

FIG. 3A schematically illustrates one micropattern of the micropillars 30 envisioned by the present disclosure. The micropillars 30 are arranged to define a series of rows 40, for example the rows 40a and 40b identified in FIG. 3A. Each of the rows 40 consists of a multiplicity of generally longitudinally aligned ones of the micropillars 30, with a longitudinal groove 50 being formed or defined between immediately adjacent (laterally adjacent) ones of the rows 40 (e.g., FIG. 3A identifies a first longitudinal groove 50a between the first and second rows 40a, 40b). The grooves 50 coincide with the intended direction of fluid flow through or along the channel 24 (FIG. 1) as represented by the arrow “F”, and in some embodiments have a transverse, sinusoidal shape or pattern that coincides with the sinusoidal grooves formed by the hierarchical structured surface of rice leaves.

With the one exemplary micropattern of FIG. 3A, the rows 40 of micropillars 30 are further grouped or arranged into sets 60, with an elevated lateral spacing L being established between immediately adjacent ones of the sets 60. For example, FIG. 3A illustrates two of the sets 60a, 60b, each consisting of three of the rows 40. In other embodiments, the sets 60 can have a greater or lesser number of rows 40 (e.g., five, ten, or more), and some or all of the sets 60 can consist of differing numbers of the rows 40. Regardless, a pitch distance P is defined between immediately adjacent ones of the rows 40 within each set 60, with the pitch distance P being the center-to-center distance between immediately adjacent and laterally aligned ones of the micropillars 30 (e.g., the pitch distance P identified in FIG. 3A is the center-to-center distance between the identified first and second micropillars 30a, 30b). The micropillar-to-micropillar pitch distance P is substantially uniform within each of the sets 60a, 60b (e.g., within 10% of a truly uniform arrangement).

The lateral spacing L is greater than the pitch distance P. For example, the first and second sets 60a, 60b can each be described as having respective first-third rows 40a-40c, 40a′-40c′. The third row 40c of the first set 60a is immediately adjacent the first row 40a of the second set 60b. The center-to-center distance between laterally aligned ones of the micropillars 30 of the first set third row 40c and the second set first row 40a′ defines the lateral spacing L (e.g., the lateral distance between the identified micropillar 30c of the first set third row 40c and the identified micropillar 30d of the second set first row 40a′).

It has surprisingly been found that the micropillar diameter D, height H, and spacing (e.g., the pitch distance P) are all important characteristics for promoting low drag, self-cleaning and/or anti-fouling. It has been shown that for similar patterns that water droplets fully penetrated the area between the micropillars 30 (transitioning from Cassie-Baxter to Wenzel regimes) when:

(\sqrt{2}P−D)²/R≧H (1)

where the known parameters are pitch (P), diameter (D), droplet radius (R), and uniform cylindrical micropillar height (H). It has surprisingly been found that that certain dimensional parameters most effectively mimic rice leaf structure geometry in the Cassie-Baxter regime. For example, in some embodiments, the micropillars 30 and corresponding micropattern have a diameter D in the range of 1-3 μm, for example 2 μm; a pitch spacing P of approximately 2D (e.g., in range of 2-6 μm, for example 4 μm); a height H in the range of 2-6 μm, for example 4 μm; and a lateral spacing L of approximately 2P (e.g., in the range of 4-12 μm, for example 8 μm). These geometries have surprisingly been found to encourage low drag, self-cleaning, and anti-fouling by ensuring superhydrophobicity, low adhesion, and anisotropic fluid control. Further, the selected pitch spacing P in accordance with some embodiments is selected to be smaller than the size of microbacteria. This configuration surprisingly deters microorganisms from colonizing at the interior face 26 (FIG. 2). In other embodiments, other dimensions can be employed.

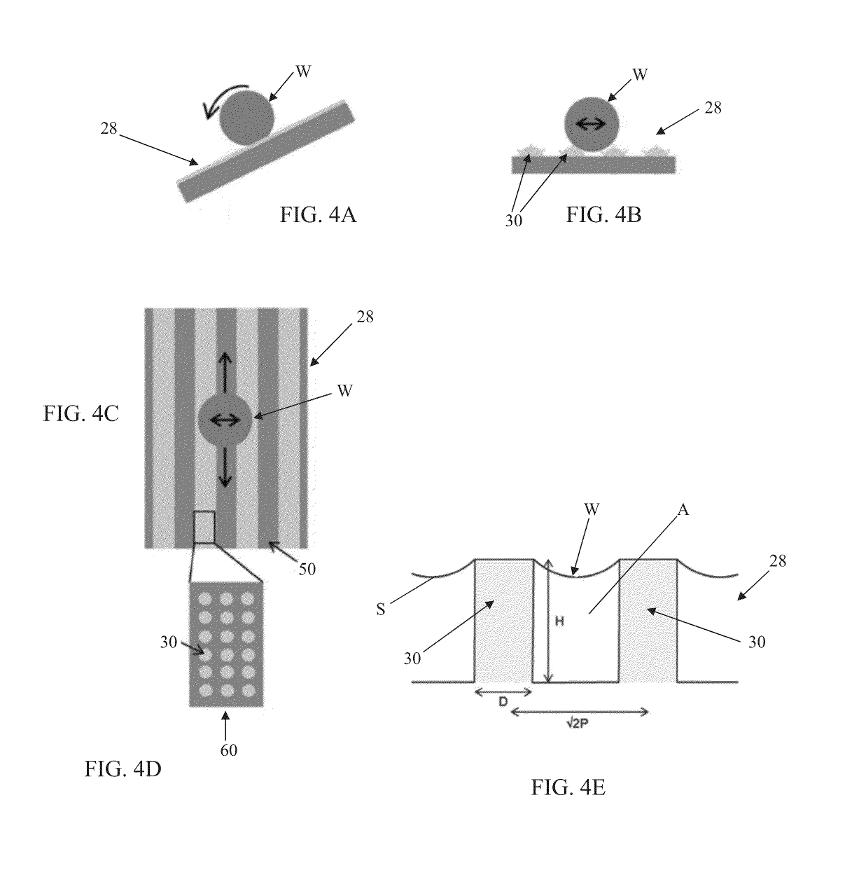

Whether the textured surface 28 (FIG. 2) is a direct replica of a sample rice leaf hierarchical structure or the more uniform construction (that still mimics the hierarchical rice leaf surface structure) of FIG. 3A (or other patterns described below), FIGS. 4A-4E illustrated simplified surface morphologies and water droplet behavior along the rice leaf-like textured surface 28. More particularly, a water droplet W is shown relative along the textured surface 28 from different perspectives in FIGS. 4A (tilt view), 4B (end view) and 4C (top view). FIG. 4D schematically reflects how the micropillars 30 can be grouped to form the sets 60 described above, or alternatively can be viewed as representing replicated rice leaf micropapillae. Arrows indicate the tendency of the water droplet W (and thus fluid flow generally) in the transverse and longitudinal directions. As shown, the rice leaf-like textured surface 28 easily repels water due, at least in part, to the optionally superhydrophobic nature of the micropillars 30 coated with the nanoparticles 34 (FIG. 2). Further, the longitudinal grooves 50 efficiently direct the water droplet W. The water droplet W sits above the micropillars 30 as shown in FIG. 4E (with air A below the water droplet bottom surface S), and can more easily roll and collect contaminants to improve self-cleaning efficiency.

Returning to FIG. 3A, while the micropattern shown reflects the micropillars 30 of adjacent rows 40 being laterally aligned with one another, in other embodiments, a lateral off-set can be established. For example, FIGS. 3B-3D illustrate other rice leaf-like hierarchical textured surface patterns in accordance with the present disclosure. With the pattern of FIG. 3B, the micropillars 30 are arranged in equidistantly-spaced rows 40, each separated by a uniform pitch spacing P. The micropillars 30 of each row 40 are laterally off-set from the micropillars 30 of an immediately adjacent row 40. A similar transverse off-set is provided with the pattern of FIG. 3C; in addition, the elevated lateral spacing L is generated between groupings or sets of the rows 40. FIG. 3D depicts a related embodiment micropattern in which the number of rows 40 within each of the sets 60 is uniform.

The micropatterned micropillars 30 of the present disclosure can have substantially identical heights H as mentioned above. In other embodiments, dual (or other) height micropatterns can be employed. For example, FIG. 3E depicts (in side view) another micropattern envisioned by the present disclosure. The micropillars 30 are arranged in equidistantly-spaced rows 40 (it being understood that a single one of the micropillars 30 of each of the rows 40 is visible in the view of FIG. 3E), each separated by a uniform pitch spacing P. Alternatively, the lateral spacing L (FIG. 3A) described above can be established between groupings or sets of the rows 40. Regardless, the height H of the micropillars 30 in each of the rows 40 varies from row-to-row, establishing the dual alternate height micropattern shown. For example, the micropillars 30 of every other row can have substantially identical heights, with the “shorter” micropillars (e.g., the micropillar 30S identified in FIG. 3E) having a height that is one-half (or some other factor) the height of the “taller” micropillars (e.g., the micropillar 30T identified in FIG. 3E). In some embodiments, the dual alternating heights are approximately 2 μm and 4 μm (+ or −0.5 μm). It has surprisingly been found that this dual height micropillar geometry, optionally in combination with other geometry features described above such as micropillar diameter D on the order of 1-3 μm, pitch spacing P of approximately 2D, and lateral spacing L of approximately 2P, encourages low drag, self-cleaning, and anti-fouling by better ensuring superhydrophobicity, low adhesion, and anisotropic fluid control. Drag reduction leading to self-cleaning can be achieved where the surfaces of the micropillars 30 are superhydrophobic/olephobic or superoleophilic.

A related embodiment textured surface 28′ in accordance with principles of the present disclosure is shown in FIG. 3F and includes a plurality of the micropillars 30 described above and arranged in a micropattern including rows 40. The textured surface 28′ further includes a plurality of microribs 70, respective ones of which are formed or provided between the micropillar rows 40. The microribs 70 can have a height greater than a height of the micropillars 30 such that the textured surface 28′ has a dual alternate height micropattern as described above with respect to FIG. 3E (e.g., the microribs 70 can have a height on the order of 4 μm and the micropillars 30 have a height on the order of 2 μm).

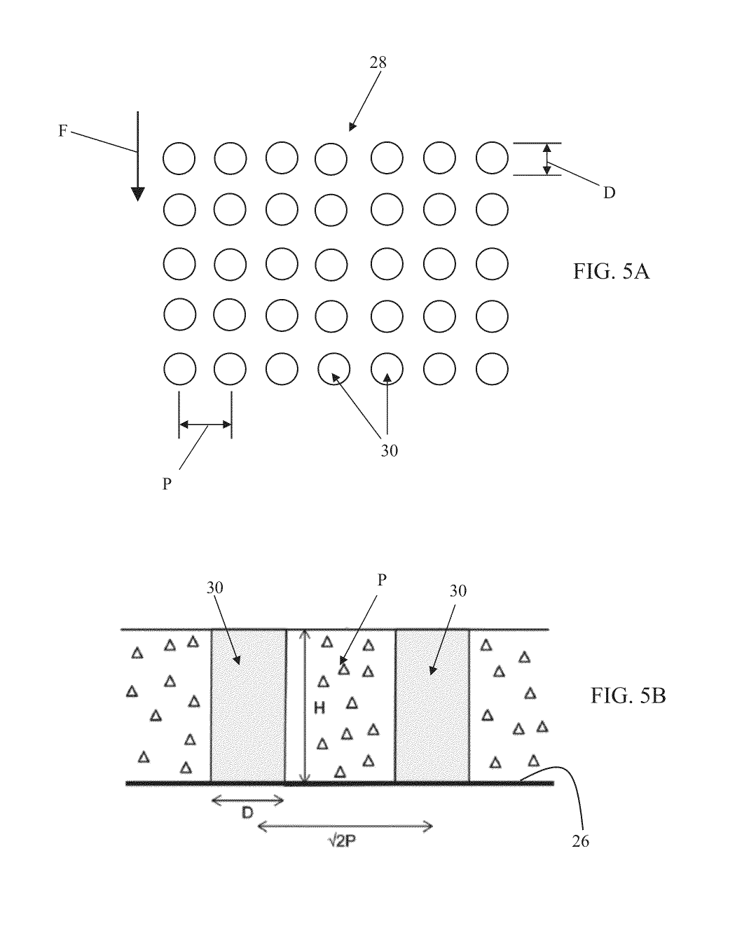

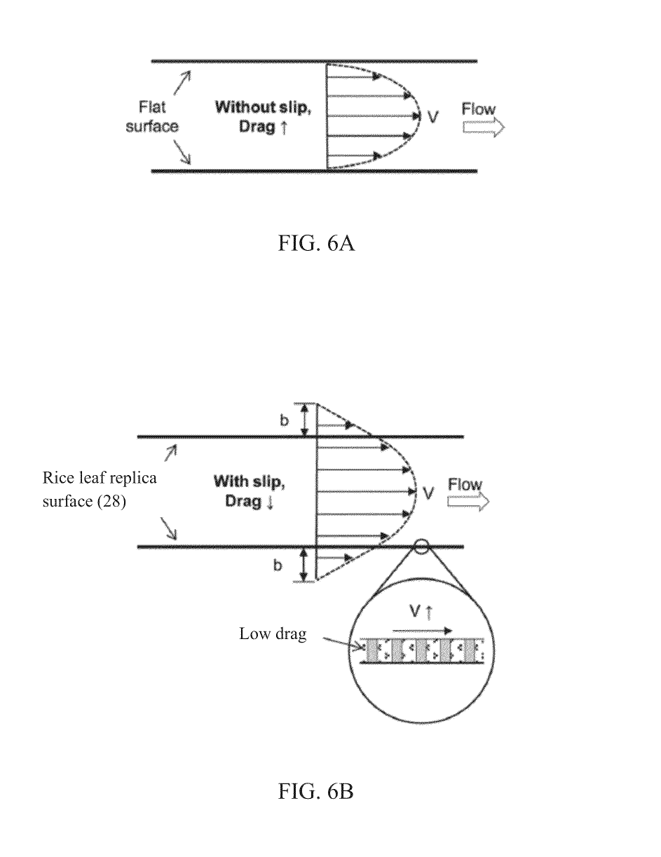

The rice leaf-like textured surfaces 28 (FIG. 2) described above provide a combination of anisotropic flow, superhydrophobicity (e.g., with embodiments including the nanostructure coating 32 (FIG. 2)), and low adhesion that leads to improved drag reduction for a number of fluids, including water as explained with reference to FIGS. 4A-4E. Similar benefits can be achieved with other liquids, including those with a higher viscosity such as oil. The flow mechanisms by which the rice leaf-like textured surfaces 28 of the present disclosure promote low drag differ with higher viscosity liquids. For example, FIG. 5A schematically reflects a rice leaf-like textured surface 28 useful for interfacing with high viscosity oil and including a plurality of the micropillars 30 arranged in evenly-spaced rows 40. The micropillars 30 have the height H (FIG. 2) and the diameter D parameters described above, and the rows 40 are arranged in accordance with the pitch distance P as with other embodiments. The micropillars 30 can be superoleophilic or superoleophobic (for example, due to the optional nanostructure coating 32 (FIG. 2)). FIG. 5B illustrates that oil O penetrates the uniformly distributed cylindrical micropillars 30 to create a trapped thin layer of oil O at the interior face 26. As described above, the rice leaf mimicking dimensions and arrangement of the micropillars 30 leads to low drag and self-cleaning. The thin oil film at the solid-liquid interface creates a slip in the adjacent fluid layer that then effectively lowers drag and increases the flow rate or velocity at the channel walls. FIGS. 6A and 6B illustrate the effects of the slip, providing a comparison of velocity profiles in closed channel flow without slip (FIG. 6A) and with slip (FIG. 6B). The thin oil film encouraged by the rice leaf-like textured surface 28 reduces drag by increasing the slip length b during oil flow. Higher slip translates into lower drag and increased flow rate. Notably, this low oil drag characteristic can be achieved with a superoleophobic or superoleophilic structure on the surfaces of the micropillars 30. Furthermore, the rice leaf-like textured surface 28 is expected to reduce adhesion with the smaller contact area as well as improve self-cleaning of contaminant particles by means of the higher flow rate at the solid-liquid interface.

Returning to FIG. 2, various methods of fabricating and/or applying the rice leaf-like textured surfaces 28 of the present disclosure are contemplated. One such method is the production of a replica of an actual rice leaf surface microstructure using structure replication, followed by the deposition of nanostructures onto the replica. Other methods include creating an original mold that mimics, but is not a direct replica of, an actual rice leaf. A number of superhydrophobic and/or superoleophobic hierarchical structures have been fabricated using molding, electrodeposition, nanolithography, spraying, colloidal systems and photolithography. Molding is a low cost and reliable way of surface structure replication and can provide a precision on the order of 10 nm. Where desired, self-assembly of the nanostructures 32 may be achieved via various methods familiar to one of ordinary skill in the art, for example, dipping, thermal deposition and/or evaporation processes.

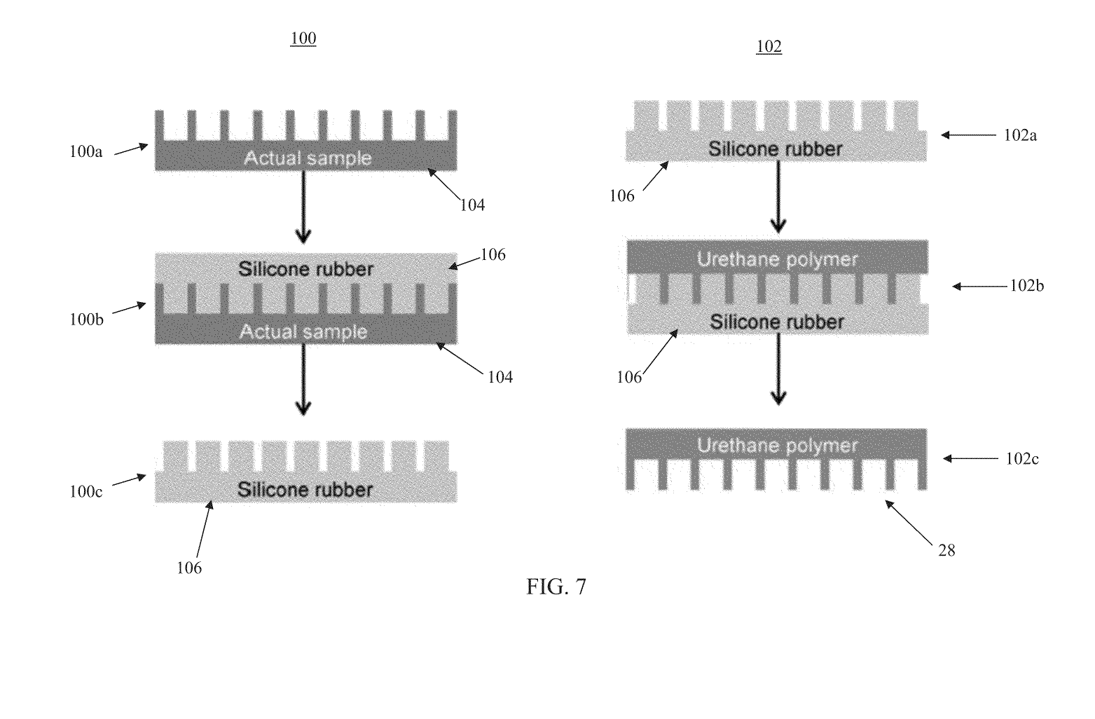

In one embodiment, replica fabrication includes a two-step soft-lithography molding procedure, reflected in FIG. 7 as steps 100 and 102. At sub-step 100a, an actual sample 104 of a rice leaf surface is initially provided. At sub-steps 100b and 100c, a negative mold 106 of the actual sample 104 is created by dispensing an appropriate molding material (e.g., liquid platinum silicone) in liquid form onto the actual sample 104 (sub-step 100b). Once cured, the negative mold 106 is removed from the actual sample 104 (sub-step 100c). The so-formed negative mold 106 is then employed to create the replica textured surface 28 at step 102. For example, a liquid polymer (e.g., urethane) is poured into the negative mold 106 (sub-steps 102a and 102b) and cured. Once cured, the negative mold 106 is removed (sub-step 102c), resulting in the positive replica rice leaf-like textured 28. A nanostructured coating can then be applied to the replica structure 28, such as by dip-coating the replica structure 28 in a solution consisting of hydrophobic nanoparticles (e.g., hydrophobized silica nanoparticles) dissolved in an appropriate solvent and binder solution.

In some embodiments, the above-described molding techniques (and other fabrication techniques known to one of skill) are employed to form the fluid conveying apparatus 20 (FIG. 1) as an integral, homogenous body. In other words, the tubular wall 22 (FIG. 1) is molded to have or form the textured surface 28 (to which the nanostructured coating 32 (FIG. 2) can optionally be applied in creating a hierarchical surface). In other embodiments, the textured surface 28 is formed apart from, and subsequently applied to, the wall 22 (or wall segments that are subsequently assembled to one another). For example, a thin, clear, adhesive-backed polymer film having the desired micropillars arranged in the micropattern as described above is generated. A master pattern is created using photolithography or other microstructured process, and then is used to emboss, or by using a variety of other imprint processes, low melting point polymer sheets using heat and/or pressure. The polymer sheet is selected such that is chemically compatible with a variety of liquids. An adhesive is applied (e.g., sprayed) on to the face of the sheet opposite the micropillars, and a release liner applied over the adhesive. When desired, the sheet can then easily be applied/adhered to the interior face of a separately formed tube (i.e., the tubular wall 22).

### EXAMPLES

### Replica Samples

A two-step molding process was used to fabricate replica rice leaf-like structure samples in accordance with principles of the present disclosure and from which sample closed channel fluid conveying apparatuses in accordance with principles of the present disclosure were constructed. Samples of rice leaf (Oryza sativa) were obtained. Using liquid platinum silicone (e.g., Smooth-On Dargon Skin 20), a negative mold was taken after cleaning the actual sample with deionized water and isopropyl alcohol. The liquid silicone ensured that details were accurately replicated and that air bubbles would rise away from the molding surface. With the silicone mold complete, a liquid urethane polymer (e.g., Smooth-On Smooth-Cast 305) was applied and cured, yielding a precise positive replica. Before casting the final positive replica as a channel-forming tube, two positive replicas were created to remove any contaminants remaining on the negative mold. A post-machining process was employed to ensure proper channel lengths.

Other replica structure samples were fabricated in a similar manner using actual butterfly wing (Blue Morpho didus), rainbow trout fish scales (Oncorhynchus mykiss) and Mako shark skin (Isurus oxyrinchus) samples.

Replicas were characterized and compared with actual samples to determine the accuracy of replication. Both scanning electron microscope (SEM, Hitachi S-4300) and optical profiler (Veeco Contour GT with Vision 64 software) images were taken, which provide evidence of surface replication success. Since fish scales and shark skin are naturally covered by mucous, the actual samples were cleaned and dehydrated prior to CA and CAH measurements (described below). Cleaning consisted of deionized water and isopropyl alcohol rinses followed by drying in a desiccator for 96 hours. Samples were then mounted with conductive paint and gold-coated prior to SEM imaging. Prior to optical profiler imaging, the samples were mounted on glass slides and then desiccator dried for 96 hours.

As described below, certain nanostructured coatings were applied to selected ones of the replica samples to provide superhydrophobicity or superoleophobicity to the replica surface. However, other ones of the replica samples did not receive a nanostructured coating, and are referred to as an “uncoated replica sample” in the testing explanations and analysis below.

### Laser Etched Riblet Samples

In addition to the shark skin replica sample described above, laser etched riblet samples were prepared that were inspired by the dogfish shark Squalus acanthias. Multiple different laser etched riblet samples were prepared having different riblet dimension. The riblet dimensions of interest include thickness (t), valley widths (vs), spacing (s), gaps (g), lengths (L), and heights (h). Riblet dimensions were incrementally varied for each sample, implementing differing h/s and t/s values. In the riblet sample descriptions below, corresponding h/s and t/s values are parenthetically provided.

### Superhydrophobic Coated Samples

To mimic the fluid interface characteristics of the actual native samples with the cast urethane replicas, the surfaces of selected replica samples were made superhydrophobic with low adhesion by using a nanostructured coating to create a roughness-induced lotus effect. This was applied on selected samples based on preliminary performance in drag and self-cleaning experiments. Various experiments were conducted to ensure that the lotus effect was achieved without detrimentally affecting the sample micro/nanostructures. Deposition variables included the particle and binder solution concentrations as well as dip rates, with contact angle and microscope measurements evaluating their effects. This resulted in superhydrophobic coated rice leaf and shark skin replicas, where the coated rice leaf replica more accurately mimics the actual rice leaf hierarchical structure. Similar lotus effect coatings are known to exhibit low drag and self-cleaning properties.

For the superhydrophobic nanostructured coating, silica particles were selected as they are known to provide high durability and transparency, if desired. Replicas were dip-coated with a solution consisting of 50 nm (±15 nm) hydrophobized silica nanoparticles (by Evonik-Degussa Corporation, Parsippany, N.J.) combined with methylphenyl silicone resin (SR355S from Momentive) dissolved in tetrahydrofuran and isopropyl alcohol. As a point of reference, this superhydrophobic coating was found to be superoleophilic, with the resultant sample structures being referenced as “superhydrophobic” or “superhydrophobic (superoleophilic)” in the discussions below.

Selected ones of the laser etched riblet samples also received the superhydrophilic nanostructured coating described above. Using the laser etched riblet Shallow (0.16, 0.31) sample as a basis, new samples were created with total and partial coatings, which are referred to as Coated riblet (0.16, 0.31) and Valleys coated riblet (0.16, 0.31), respectively. The Valleys coated riblet sample simulated actual shark skin, where slippery mucous is present between the riblet tips in the so-called Valleys. Contact angle and microscope measurements ensured that the superoleophilicity was achieved without detrimentally affecting the sample micro/nanostructures.

### Superoleophobic Coated Samples

To investigate the role of superoleophobicity, a superoleophobic coating was applied to other selected ones of the replica samples. To create the superoleophobic coating, a two-step, nanotechnology-based oleophobic coating available from UltraTech International, Inc. of Jacksonville, Fla. under the trade designation EverDry® SE 7.6.110 was applied. The base and top coats of the EverDry® system were individually applied with an internal mixing double action airbrush using laboratory air at 30 psi. As a point of reference, the so-created superoleophobic surfaces were also found to be superhydrophobic.

In the discussions below, reference to a “superhydrophobic” sample, a “superhydrophobic (superoleophilic)” sample, or more simply a “coated” sample refers to a replica or laser etched riblet sample coated with the superhydrophobic nanostructured coating above unless noted otherwise, whereas reference to a “superoleophobic” sample refers to a replica sample coated with the superoleophobic coating of this section.

### Closed Channel Constructions

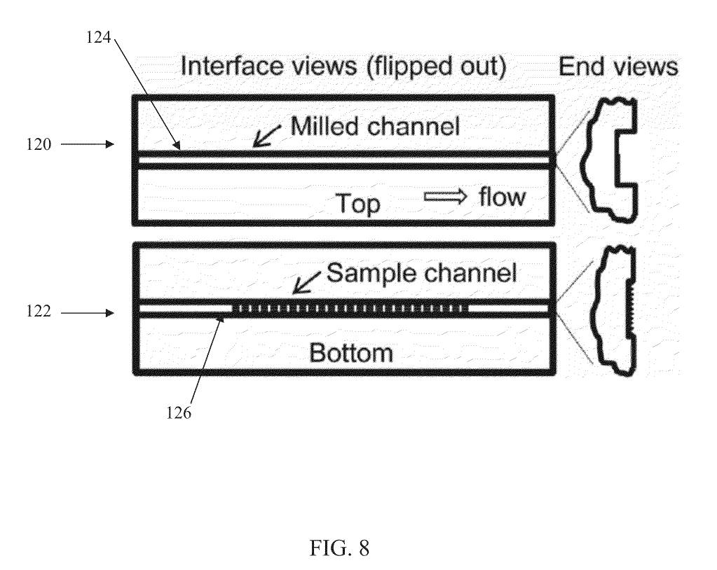

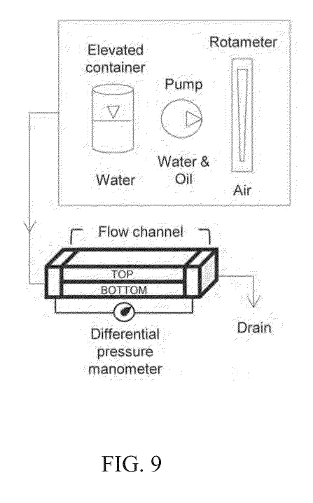

Various ones of the uncoated replica and laser etched riblet samples, superhydrophobic samples, and superoleophobic samples were fabricated into closed channel fluid conveying apparatuses. The channels were formed to have a rectangular cross-sectional shape, and was inspired by hospital catheter tubes (3-5 mm diameter) commonly used in the healthcare industry to transport aqueous fluids. A rectangular sandwich design (i.e., two half sections that combine to define, when assembled, a complete closed rectangular channel) was selected, where the sample structure was applied to one side and then sandwiched together with the second channel section. FIG. 8 schematically illustrates the two channel sections, including a top section or side 120 and a bottom section or side 122. An interior surface of the top side 120 formed a milled channel 124, whereas the sample structure being tested was applied to the bottom side 124 as indicated at 126. With the top and bottom sides 120, 122 assembled, the rectangular duct flow channel measured 0.7 mm high, 3.3 mm wide, and 101 mm long.

### Testing: Pressure Drop

FIG. 9 illustrates an experimental system used to measure fluid drag via pressure drop for air, water and oil flow experiments. To achieve desired Reynolds numbers, experiments were conducted with an elevated container, syringe pump (New Era Pump Systems NE-300), and laboratory air. The two sample flow channel halves were carefully aligned, sealed with gaskets, clamped, and then purged off air bubbles (for water and oil experiments). Each sample was measured with an optical microscope and calipers to ensure accurate flow rate and theoretical pressure drop measurements. Flow velocity was determined by dividing the volumetric flow rate by the channel cross-sectional area.

For water experiments, water was pumped from a reservoir to the elevated container (via the fill line), which then flowed down the supply line. To ensure a constant flow rate, the control valve and overflow line regulated the water level and the flow rate (thus Re number) was varied by changing the container elevation. The syringe pump delivered water flow at low velocities (0.04-0.09 m/s), while the elevated container provided higher velocity water flow (2-5 m/s).

For air flow experiments, laboratory air connected to an adjustable Omega FL-1478-G rotameter allowed for incremental variation of the flow velocity (4-33 m/s). The laboratory airflow velocity was calculated based on the rotameter reading and the channel cross-sectional area.

For oil experiments, white paraffin oil (Carolina CAS number 8012-95-1) was selected due to its low surface tension, chemical compatibility with samples, and low health hazard. This selection and criteria are similar to the oil used in the so-called Berlin oil channel. To achieve a wide range of constant flow rates, oil was pumped into the closed channels using the syringe pump and a miniature gear pump (Cole-Parmer EW-07012-30). The syringe pump provided oil flow at low velocities (0.02-0.14 m/s) whilst the gear pump provided oil flow for the high velocity (3.5-4.5 m/s). The high velocity oil flow rate was chosen to simulate conditions found in oil pipeline applications.

To maintain kinematic viscosity, fluid temperature was monitored with a CND DTQ450X digital thermometer, and held constant (18.5-21° C.). The pressure drop between the inlet and outlet was measured with an Omega PX26-005DV differential manometer (potted in RTV silicone). Data were collected at 10 Hertz for 30 seconds with a Vishay 2311 Laboratory Amplifier and a Measurement Computing USB-1208LS DAQ card. The system was calibrated prior to use with an Ametek RK-1600W6 pneumatic pressure system.

To confirm that the system was behaving properly (e.g., detecting possible leaks and misalignments), the measured value were compared to predicted pressure drop. This was done by comparing the flat experimental sample channel to the predicted values. It also allows for a baseline comparison when reporting pressure drop percentage values. Predicting pressure drop of a flat rectangular duct requires the use of the incompressible flow equations for straight uniform pipes. Since the Mach number is less than 0.3 for all experiments, incompressible flow equations may be used. The predicted pressure drop was calculated using the total channel cross-sectional area.

Pressure drop (Δp) between two points in a straight uniform closed channel with incompressible and fully developed flow is found with the Darcy-Weisbach formula:

$$Δ p = \frac{ρ {V}^{2} fL}{2 D} \qquad ( 2 )$$

where ρ is the fluid density, V is the flow velocity, f is the friction factor, L is the length between two points on a channel, and D is the hydraulic diameter. Flow velocity (V) is determined by dividing the volumetric flow rate by the channel cross-sectional area. In air experiments, the rotameter values were used with manufacture provided charts to determine the flow velocity.

The rectangular duct hydraulic diameter is:

$$D = \frac{2 ab}{a + b} \qquad ( 3 )$$

where a is the width and b is the height.

The friction factor (f) for rectangular duct flow is:

$$f = \frac{64}{Re} / [ \frac{2}{3} + \frac{11}{24} \frac{b}{a} ( 2 - \frac{b}{a} ) ] \qquad ( 4 )$$

where b/a≦1.

Eq. 4 shows that the friction factor is dependent on channel geometry and independent of the surface roughness. In order to account for roughness, friction factor values for pipes can also be found with the Moody chart.

### Testing: Self-Cleaning Measurements

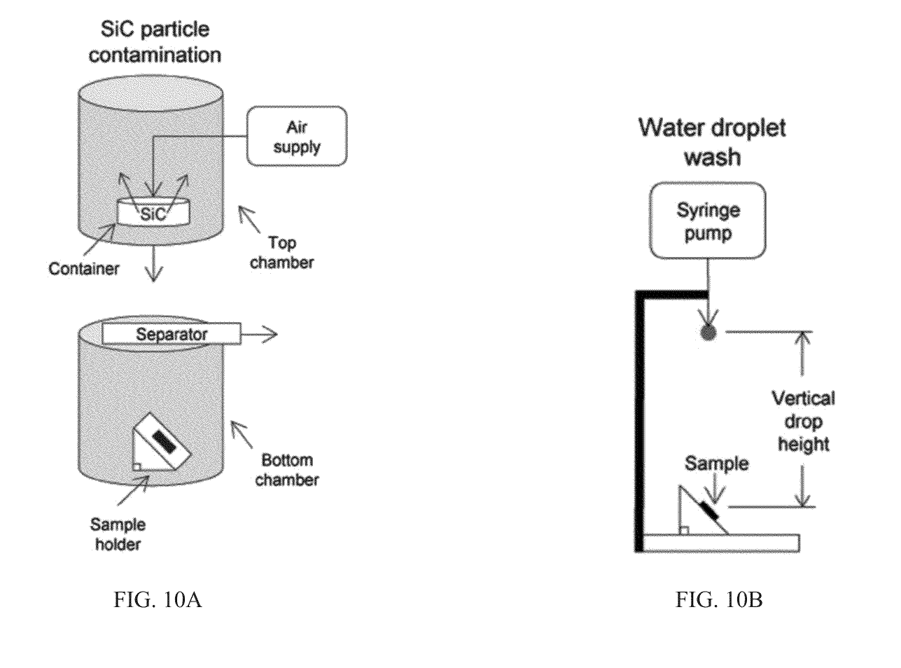

Self-cleaning experiments were conducted by contaminating selected samples, employing a wash technique, and determining the percentage of particles removed. Depositing contaminated particles on tilted (45°) samples involved a glass contamination chamber (0.3 m diameter and 0.6 m high), as shown in FIG. 10A. A tray containing 0.2 g of hydrophilic silicon carbide (SiC) contaminants (400 mesh particle size by Aldrich, with sizes ranging from 10-15 μm) was placed in the top chamber with an air hose directed in the center. These particles were chosen because of their similar properties to natural dirt (shape, size and hydrophilicity). Contaminants were blown with laboratory air for 10 seconds at 300 kPa, and then allowed to settle for 30 seconds before the separator panel was removed. After 30 minutes, the sample was removed and subjected to prewash experiment particle analysis. Using an optical microscope and a CCD camera (Nikon, Optihot-2), a 280 μm by 210 μm area of the sample being tested was imaged and analyzed with image processing software (SPIP 5.1.11, Image Metrology A/S, Horsholm, Denmark) in order to quantify the total number of particles. The software recognizes contaminating particles as dark areas and counts the total number. This process was performed before and after each wash experiment.

Wash experiments consisted of exposing the tilted (45°) sample to water droplets falling from a specified height and drip rate (total duration of 2 min using 10 μt, water at 18.5<temp.<19° C.). The syringe pump and tubing were positioned relative to the sample being tested as shown in FIG. 10B. Droplet velocities reflect the flow rates found in laminar through turbulent flow regimes, with velocities approximating 1 and 5.6 m/s at heights of 0.02 and 0.4 m, respectively. This translates into kinematic energies of 200 and 4000 Pa, respectively.

### Testing: Wettability

Wettability plays a significant role in self-cleaning, for instance as found in nature with the superhydrophobic lotus leaf of superhydrophilic pitcher plant. With the lotus effect, a high contact angle (CA) coupled with low contact angle hysteresis (CAH) repels many liquids and may remove contaminant particles. With the pitcher plant effect, a thin surface water film encourages the shearing effect that may also remove contaminant particles. To understand the effects of wettability, the apparent contact angle (CA) and contact angle hysteresis (CAH) were measured for selected actual, uncoated replica and coated replica samples. CAH is the difference between the advancing (downhill side) and receding (uphill side) contact angles, which is lower for Cassie-Baxter (droplet sitting on top of asperities) and higher for Wenzel (droplet penetrating gaps between asperities) regimes. Various CA and CAH measurement tests were performed with water and air droplets; and for completeness oil droplet CA was measured under water for selected samples.

Water droplet measurements were taken with an automated goniometer (Rame-Hart model 290-F4) that gently deposited 5 μL, (approximately 1 mm diameter) water droplets onto the sample surfaces. Similar sized oil droplets were deposited using a microliter syringe (Hamilton model 701 with volume of 10 μL). For both water droplet and oil droplet testing, CAH was determined by tilting the sample until the droplet began to move (up to 90°), and subtracting the advancing and receding contact angles.

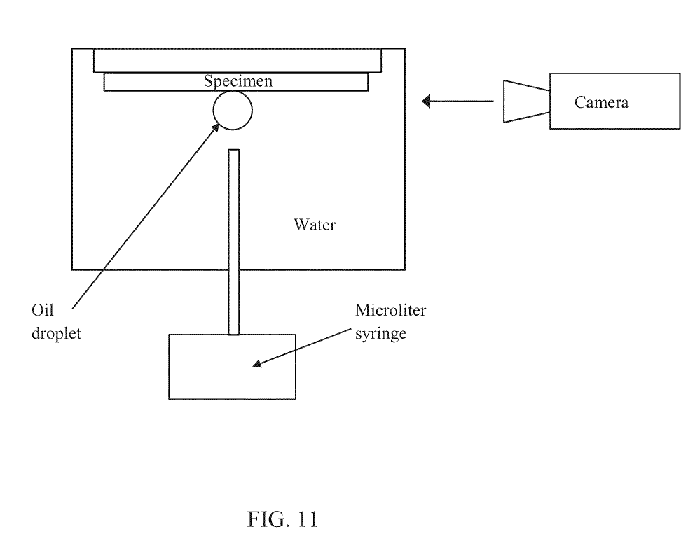

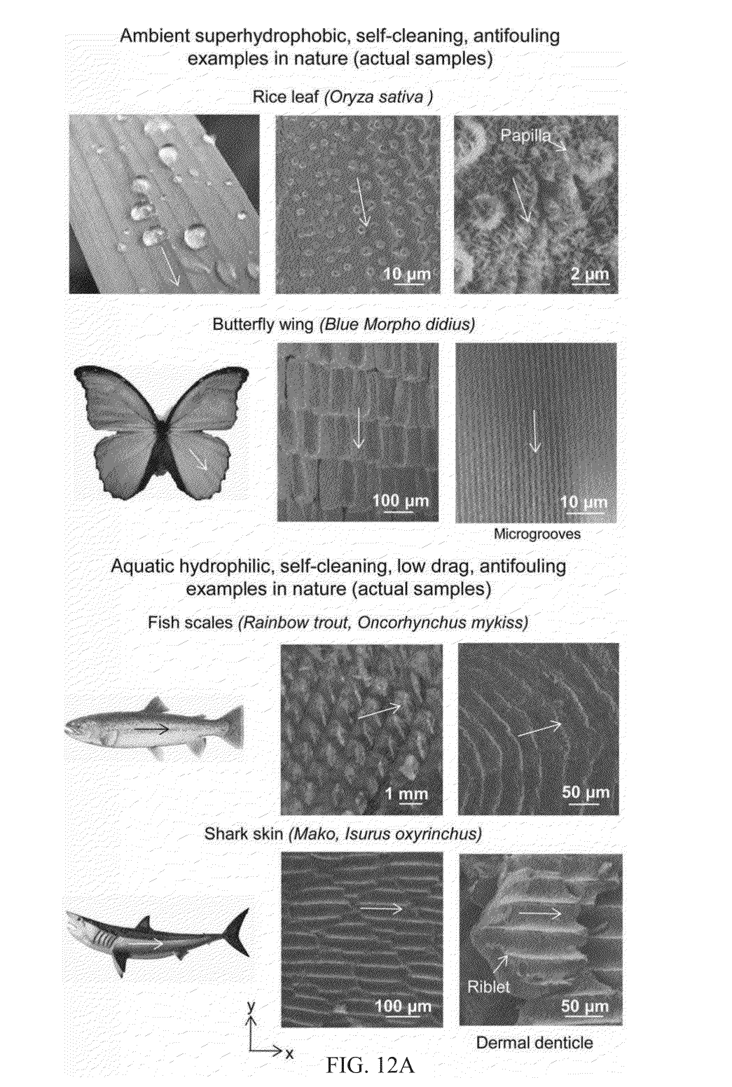

Measuring oil droplet CA under water at the solid-water-oil interface is useful when considering self-cleaning efficiency of underwater surfaces contacting oil, or vice versa, where superoleophobicity may repel contaminants. Clean surfaces encourage low drag, so therefore self-cleaning is necessary for underwater applications where oil contaminants are present. FIG. 11 shows the experimental apparatus used to measure the contact angle at the solid-water-oil interface. Since the density of white paraffin oil (880 kg m⁻³) is lower than that of water (1000 kg m⁻³), the oil droplet was deposited with the sample inverted. Droplets of approximately 1 mm diameter (5 μL) were deposited using the microliter syringe (Hamilton model 701 with volume 10 μL). Measurements were taken and images captured with the automated goniometer (Rame-Hart model 290-F4).

Since fish scales and shark skin are naturally covered by mucous, the actual samples were cleaned and dehydrated prior to CA and CAH measurements. Cleaning consisted of deionized water and isopropyl alcohol rinses followed by drying in a desiccator for 96 hours. It was found that dried shark skin soaks in the water droplet before the CA or CAH can be measured. It was not necessary that the rice leaf or butterfly wing actual samples be subjected to washing or dehydrating preparation.

### Results: Sample Characterizations

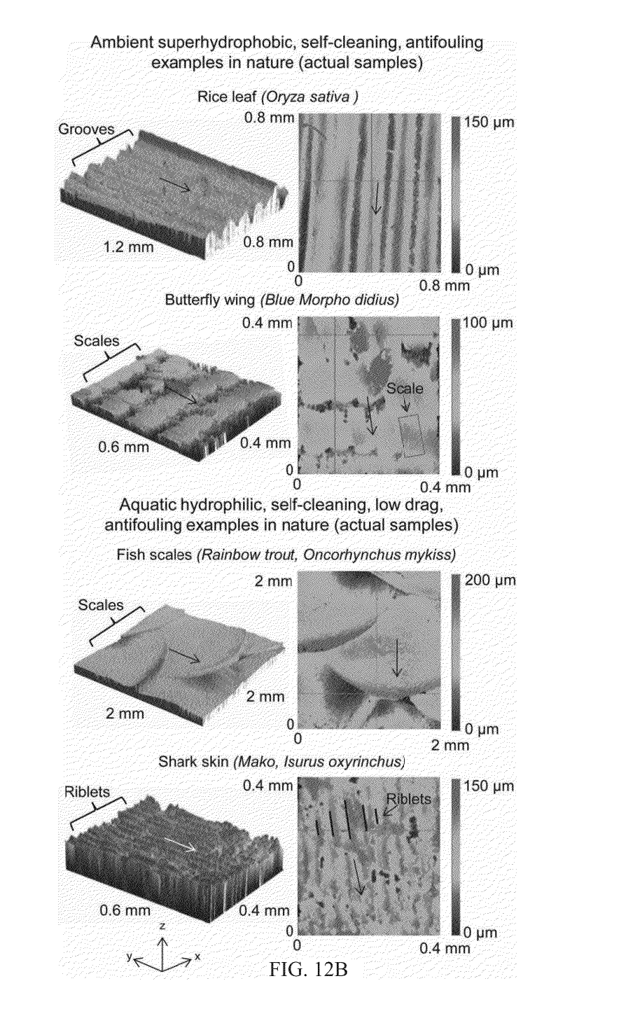

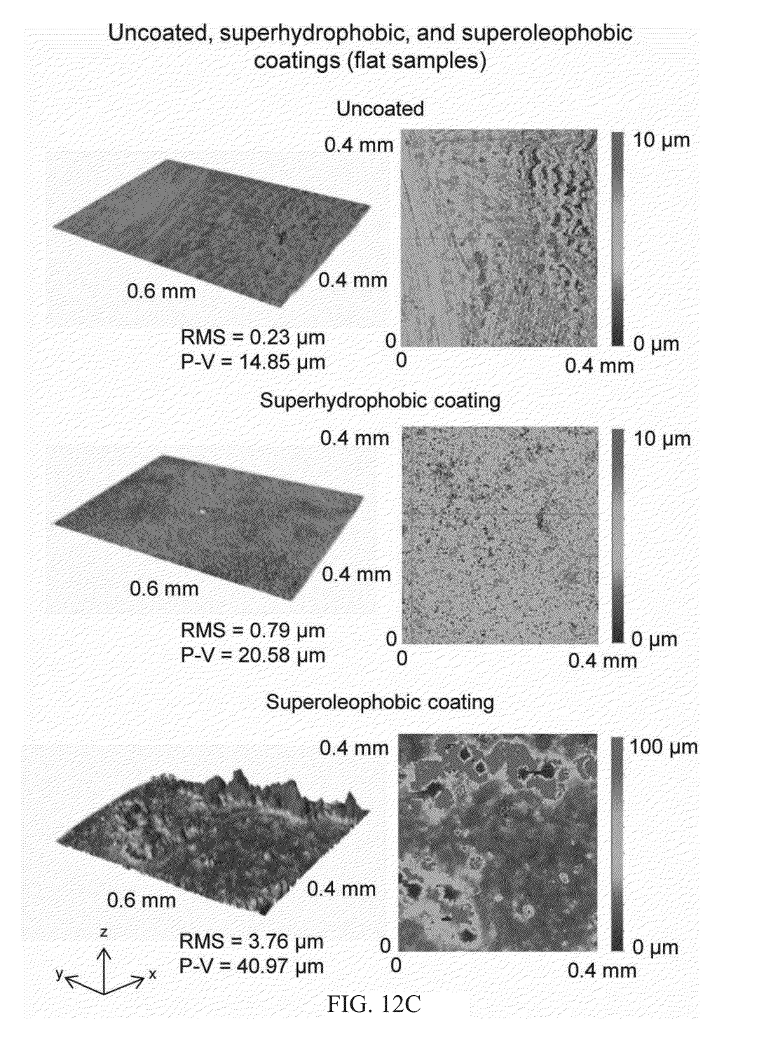

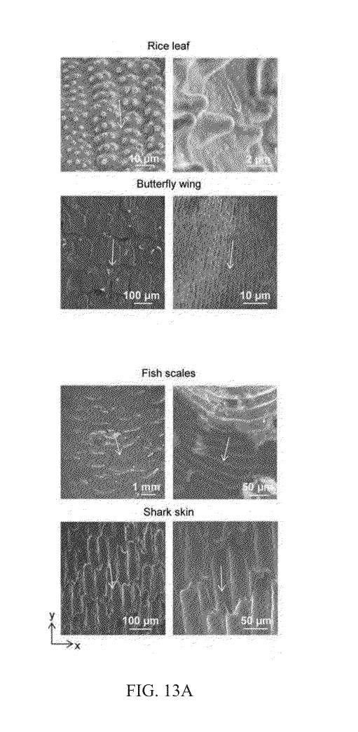

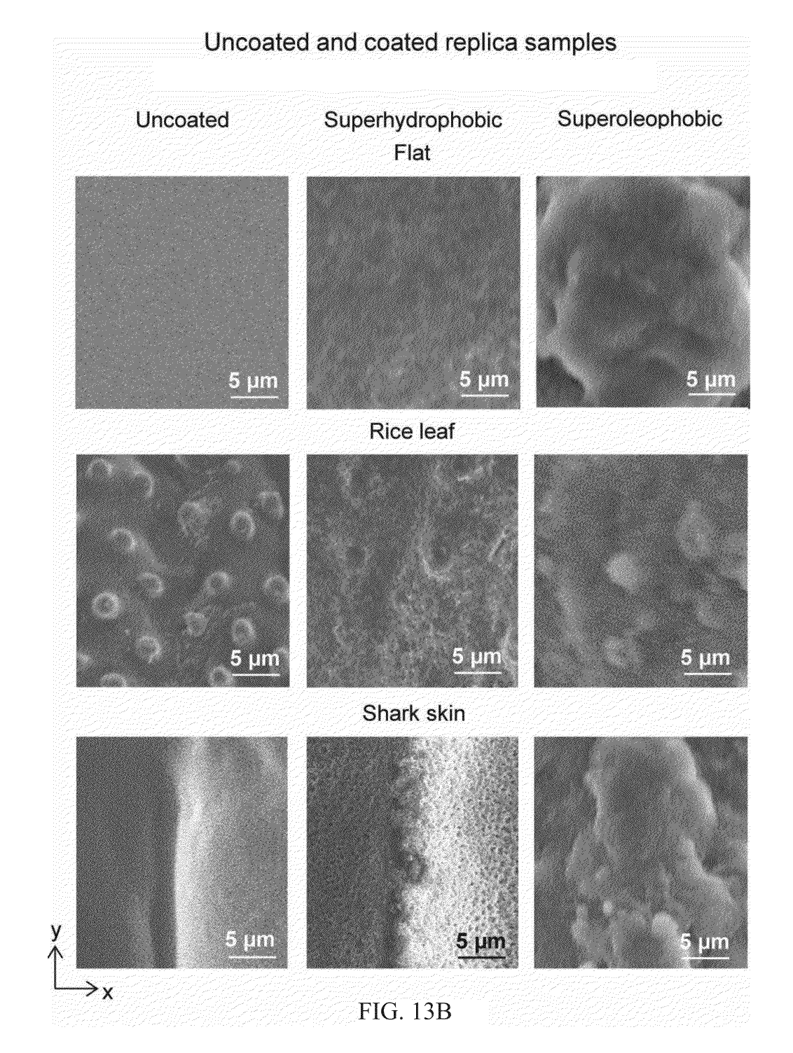

To characterize the actual and replica samples, an SEM and an optical profiler were employed for a qualitative and quantitative comparison and understanding of the relevant mechanisms, as shown in FIGS. 12A-13B. Arrows indicate the fluid flow direction for each sample. In addition, a digital camera provided the lowest magnification fish scale images (due to the relatively large size) whilst the other samples were exclusively imaged with the SEM and optical profiler. The SEM provides high resolution in the x/y direction whereas the optical profiler provides high resolution height map information in the z direction. By using these two imaging techniques, both micro and nano scale surface structure details are recorded.

SEM images in FIG. 12A show the surface structures of actual rice leaves and butterfly wings samples (or “ambient” actual samples), as well as actual fish scales and shark skin samples (or “aquatic” actual samples). Rice leaves are found to have a sinusoidal groove patterned surface. The cylindrically tapered micropapillae superimposed by waxy nanobumps create hierarchical structures. The nanobumps are expected to be formed by self-assembly of the epicuticular wax, as reported in the case of the lotus leaf. Butterfly wings consist of aligned shingle-like scales with aligned microgrooves oriented radially. Also shown are surface structures of fish scales and shark skin. Fish skin is comprised of oriented scales with concentric rings overlapping and hinged such that water flow is from head to tail. Shark skin is comprised of oriented diamond-shaped dermal denticles (“little skin teeth”) that are each covered with five tapered ridges called riblets. The dermal denticles are also overlapping and hinged such that the riblets are aligned in the water flow direction from head to tail. It should be noted that shark skin surface structures vary from species to species.

Optical profiler images in FIG. 12B provide three dimensional renderings and height maps of each actual sample, showing rice leaf sinusoidal grooves not clearly observed in the SEM images. The nanostructured coatings are highlighted in FIG. 12C, illustrating the differences between flat/uncoated, the superhydrophobic coating, and the superoleophobic coating. As shown, the surface roughness is highest with the superoleophobic coating. FIG. 13A shows SEM images of the replica samples. FIG. 13B provides SEM image examples of flat, rice leaf replica, and shark skin replica samples, uncoated, coated with the superhydrophobic coating, and coated with the superoleophobic coating. As expected the rice leaf micropapillae hierarchical structure detail was not reproduced in the uncoated replica rice leaf sample. Furthermore, the coating increases surface nanoroughness as compared to the uncoated replicas.

Information was gathered from SEM and optical profiler images at different magnifications to measure features of interest as summarized in Table 1 below. The x, y, and x-spacing dimensions were determined from SEM images by estimations based on the scale bars, with the exception of the rice leaf grooves and fish scales that were determined with the optical profiler. The z-dimensions and peak radiuses were estimated from optical profiler cross-sectional height maps, using objective zooms ranging from 5× to 100×.

TABLE 1
Physical characterization of surface structures from actual samples

| | Actual | | | | | | |
|---|---|---|---|---|---|---|---|
| | | | | x-dim/ | | | Peak |
| | | | z-dim | diameter | y-dim | x-spacing | radius |
| Sample | Description | | (μm) | (μm) | (μm) | (μm) | (μm) |
| Rice leaf | Sinusoidal grooves | Grooves | 125-150 | 150-175 | Full | 150-175 | 5-10 |
| (Oryza) | array covered with | | | | length | | |
| sativa | micropapilla and | Micropapillae | 2-4 | 2-4 dia | n/a | 5-10 | 0.5-1 |
| | nanobumps | | | | | | |
| Butterfly | Shingle-like scales | Scales | 30-50 | 50-75 | 100-125 | 50-75 | n//a |
| wing (Blue | with aligned | Microgrooves | 1-2 | 1-2 | 100-125 | 1-2 | 0.5-1 |
| Morpho | microgrooves | | | | | | |
| didius) | | | | | | | |
| Fish scales | Overlapping hinged | Scales | 175-200 | 2-2.5 | n/a | 1-1.25 | n/a |
| (Oncorhynchus | scales with concentric | | | mm dia | | mm | |
| mykiss) | rings | Rings | 5-8 | 0.1-2.5 | n/a | 20-25 | 1-2 |
| | | | | mm dia | | | |
| Shark skin | Overlapping dermal | Dermal | 75-100 | 150-175 | 135-150 | 150-175 | n/a |
| (Isurus | denticles with | denticles | | | | | |
| oxyrinchus) | triangular cross | Riblets | 10-15 | 15-25 | 100-150 | 30-50 | 1-2 |
| | sectional riblets | | | | | | |

### Results: Pressure Drop

To understand the drag effects of replicas with water, oil, and air flow, the results of a series of the pressure drop experiment described above are presented below. In many of the graphs discussed, one plot shows the predicted pressure drop for a flat rectangular channel using Eqn. 2 to estimate pressure drop for a milled channel. In order to account for milled channel surface roughness, friction factor values from the Moody chart were selected based on the roughness value ε=0.0025 mm. Additionally, many of the plots show the milled channel control sample for comparison, and percentage pressure drops are calculated from the control samples.

Results: Pressure Drop with Water Flow

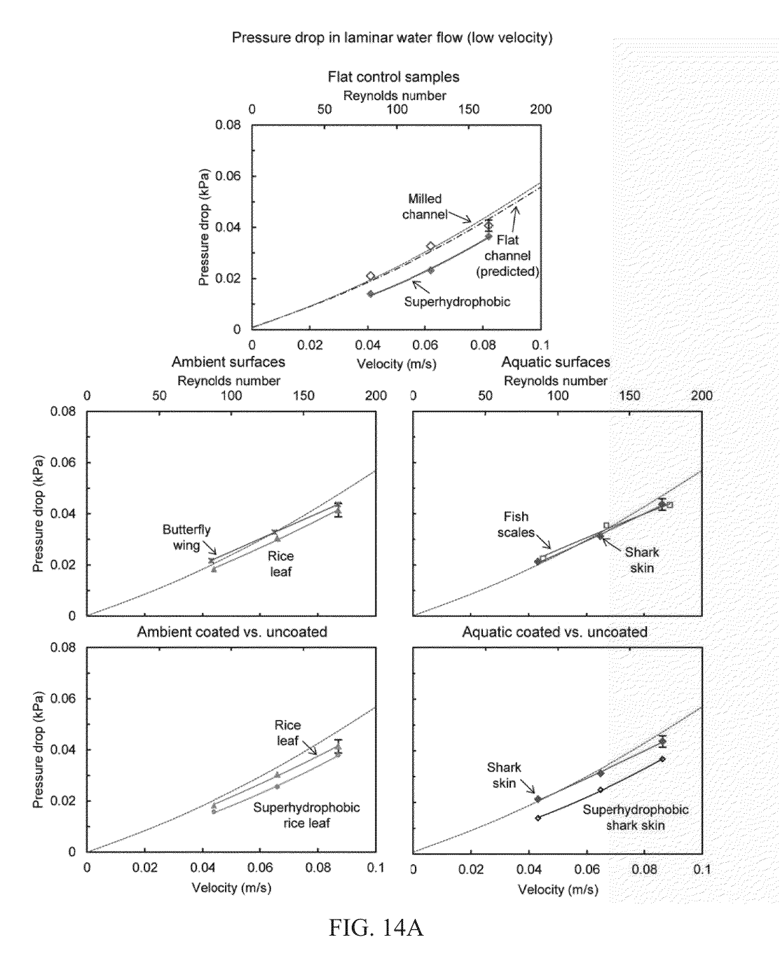

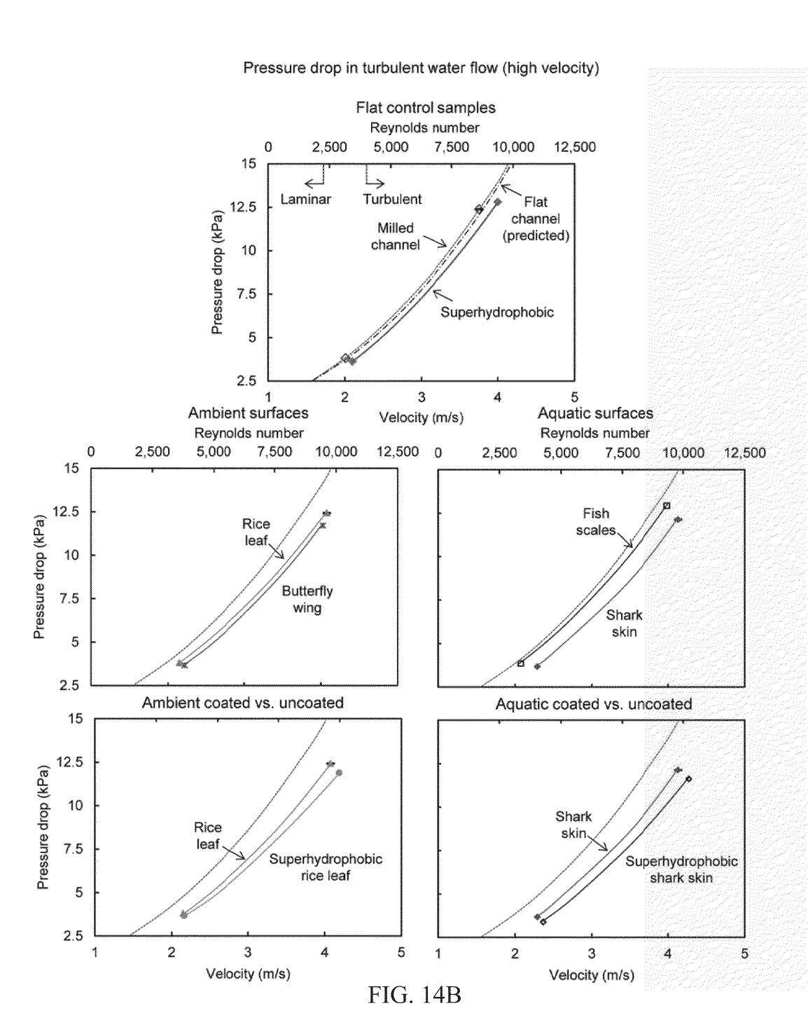

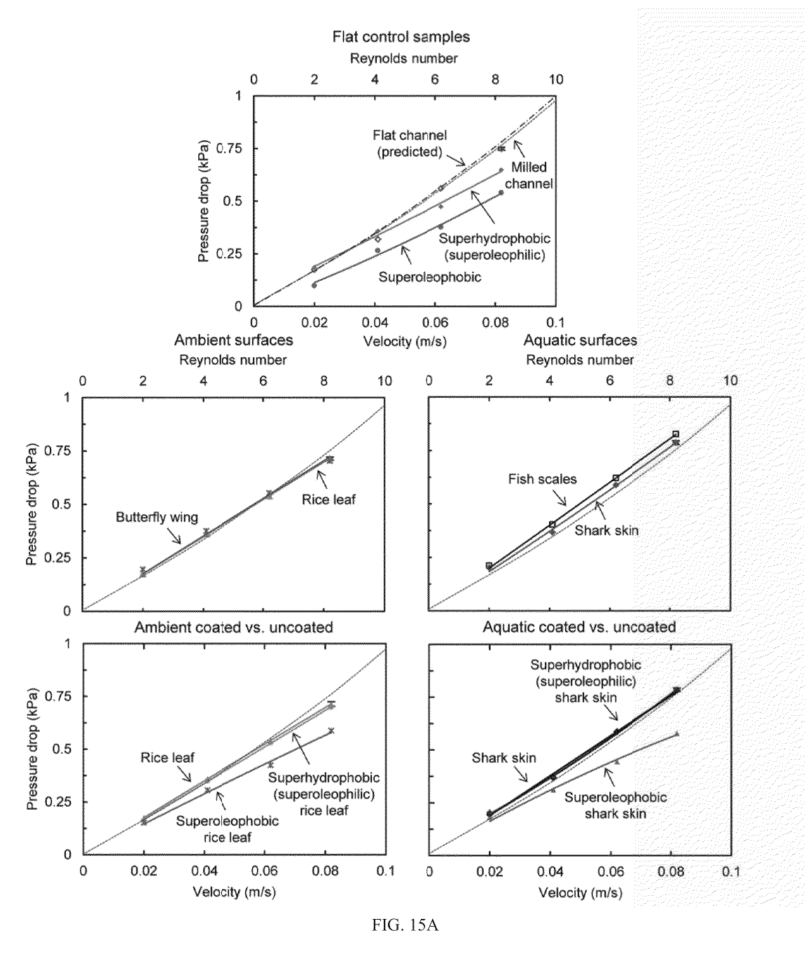

FIG. 14A shows results from the water flow pressure drop experiments with laminar low velocity flow (0<Re<200), and FIG. 14B with turbulent high velocity flow (0<Re<12 500), with trend lines connected to the origin. Calculations used the values for mass density (ρ) equaling 1000 kg m⁻³ and kinematic viscosity (ν) equaling 1.034×10⁻⁶ m² s⁻¹.

The top rows of FIGS. 14A and 14B show the flat milled and superhydrophobic control samples compared with the predicted pressure drop for a flat rectangular duct channel. The middle rows shows ambient and aquatic replicas, where a difference is detected at the higher flow velocities. The rice leaf and butterfly wing replica sample pressure drops are similar at low and high velocity. At high flow velocity, the replica shark skin sample shows a pressure drop improvement over the fish scales.

The bottom rows show superhydrophobic coated and uncoated rice and shark skin replicas and results indicate that the coating offers improvement. The greatest benefit is shown in higher flow velocity conditions. In laminar water flow, the maximum pressure drop reduction of 26% was found with the superhydrophobic flat sample. In turbulent water flow, maximum pressure drop reduction is shown with superhydrophobic coated rice leaf and shark skin replicas at 26% and 29%; and uncoated at 17% and 19%, respectively. These values compare to other rectangular duct experiments conducted with micro-sized pillar photolithography samples, which yielded pressure drop reductions in laminar and turbulent flows. It has been surmised that the superhydrophobic rice leaf replica sample benefits from anisotropic flow and low adhesion, which leads to lower drag. In addition, the superhydrophobic shark skin replica benefits from the shark skin effect combined with low adhesion, which also leads to low drag.

Results: Pressure Drop with Oil Flow

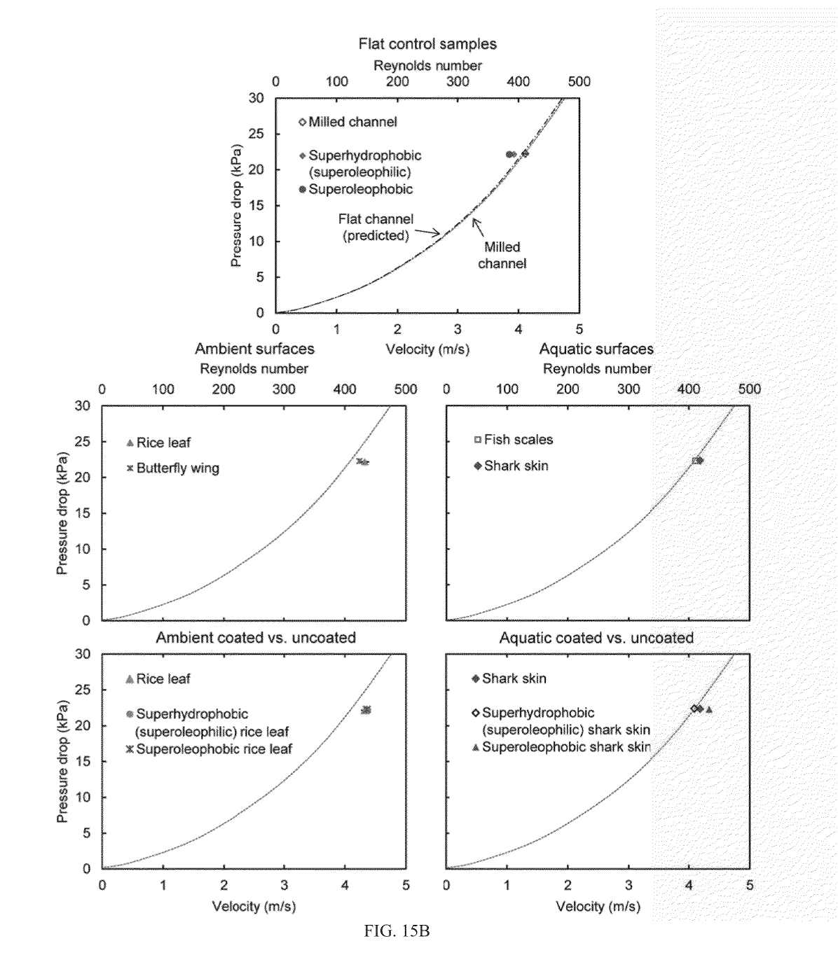

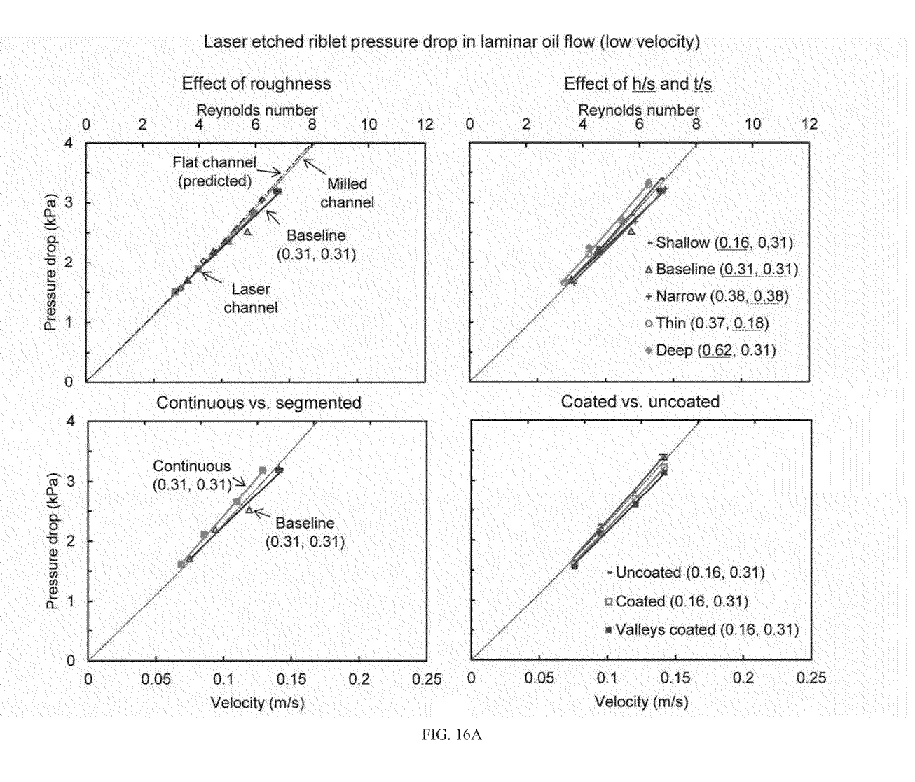

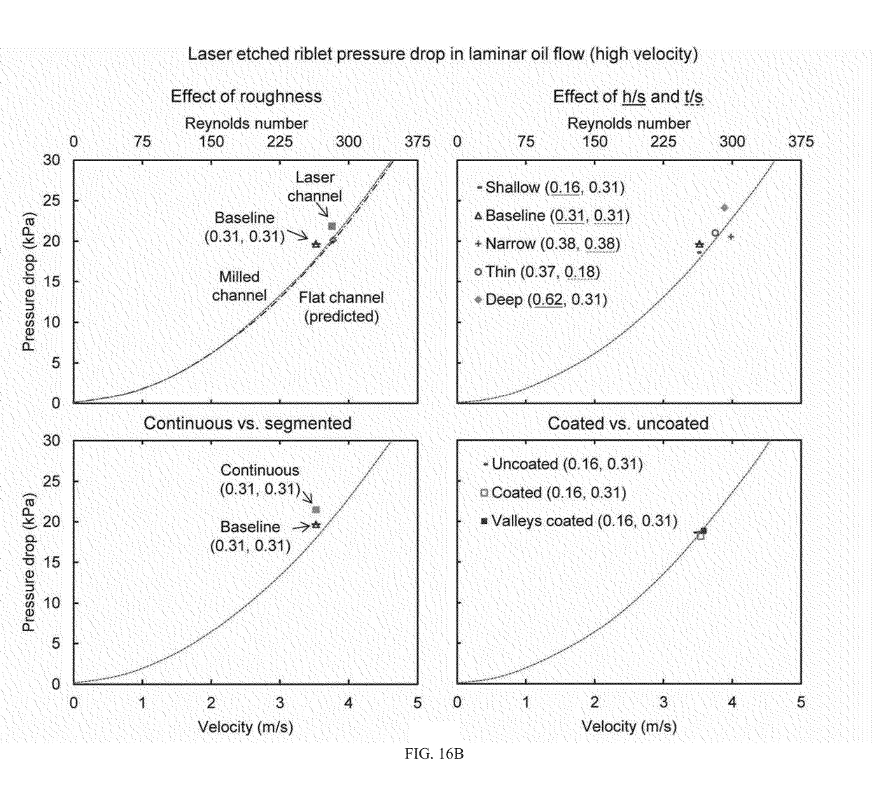

The oil flow pressure drop test results for the replica samples are shown in FIGS. 15A and 15B, comparing the flat control, ambient, aquatic, and coated versus uncoated samples. Results are shown from experiments with low velocity laminar oil flow (0<Re<10) in FIG. 15A, and high velocity laminar oil flow (0<Re<500), with trend lines connected to the origin. To investigate the role of superoleophobicity, several of the superoleophobic coated samples were also tested. Calculations used a mass density (ρ) of 880 Kg m⁻³ and kinematic viscosity (ν) estimated at 2.2×10⁻⁵ m⁻¹ s⁻¹.

The top rows of FIGS. 15A and 15B show the flat milled superhydrophobic (superoleophilic) and superoleophobic control samples compared with the predicted pressure drop for a flat rectangular closed channel. The superoleophilic and superoleophobic flat samples at high velocity revealed that drag increases, which is presumably due to the lack of anisotropic flow control and increased surface roughness. The middle rows show ambient and aquatic replicas, where a pressure drop reduction is detected at the high velocities for the rice leaf and butterfly wing replica samples. At the high velocity, the rice leaf, coated rice leaf, and butterfly wing samples show greater pressure drop reduction than at the low velocity. However the shark skin, coated shark skin, and fish scales show increased drag at the low flow rates, and negligible difference from the milled control sample at the high velocity. The bottom rows show superhydrophobic (superoleophilic) and superoleophobic coated and uncoated rice leaf and shark skin replica samples. Results indicate that the coating offers improvement for the rice leaf and not for the shark skin.

At the high and low velocities, the superoleophobic rice leaf and shark skin replica samples provide drag reduction, due to anisotropic flow and low adhesion. In addition, the superhydrophobic (superoleophilic) rice leaf replica sample provided drag reduction due to the thin film effect described below.

In general, the greatest benefit is shown in high velocity conditions. It is surmised that this is due to the formation of a thin oil film at the boundary layer interface, thus increasing the slip length. It is further surmised that the replica of rice leaf morphology retains a thin oil film where oil fully penetrates the microstructures at the boundary layer to reduce drag, thus benefiting from the Wenzel state. This drag reducing state is amplified with the nanostructured coating that further increases the oleophilicity. The coated shark skin replica does not perform as well as the coated rice leaf replica, which is likely due to the absence of the thin oil film. It is surmised that oil is not trapped as speculated in the rice leaf, due to the riblets oriented in the flow direction. Rice leaf micropapillae are oriented such that oil remains stationary in between the micropapillae. With low Reynolds numbers, turbulent vortices are not formed and thus the shark skin effect is not present in these experiments. In high velocity (4.3 m s⁻¹), maximum pressure drop reduction is shown with superhydrophobic (superoleophilic) and superoleophilic coated rice leaf and butterfly wing replica samples at 10% and 6%, respectively.

The pressure drop test results for the laser etched riblet samples are presented in FIGS. 16A and 16B comparing the effect of roughness, effect of h/s and t/s, continuous versus segmented, and coated versus uncoated samples. Results are shown from experiments with low velocity (0<Re<12) and high velocity (0<Re<375) laminar oil flow, with parabolic trend lines connected to the origin. The top rows report the milled channel control sample compared with the predicted pressure drop for a flat rectangular closed channel. In low velocity flow, the differences between milled, laser, and baseline laser etched riblet (0.31, 0.31) samples are indistinguishable, whereas with higher velocity the rougher laser and baseline (0.31, 0.31) samples show increased drag. Furthermore, samples comparing the effect of h/s and t/s each show increased drag, except the Narrow laser etched riblet (0.38, 0.38) sample. It is surmised that this sample creates a thin oil film with oil trapped between the narrow riblets, thus increasing the slip length. The continuous laser etched riblet (0.31, 0.31) shows the highest drag increase, likely due to the increased wetted surface area. Compared to their uncoated counterpart, the coated (0.16, 0.31) and Valleys coated laser etched riblet (0.16, 0.31) samples show drag reduction at low velocities but not at the higher velocity. Once again with low Reynolds numbers, turbulent vortices are not formed and thus the shark skin effect is not present in these experiments. In high flow velocity (4 m s⁻¹), maximum pressure drop reduction is shown with the Narrow laser etched riblet sample at 9%.

Results: Pressure Drop with Air Flow

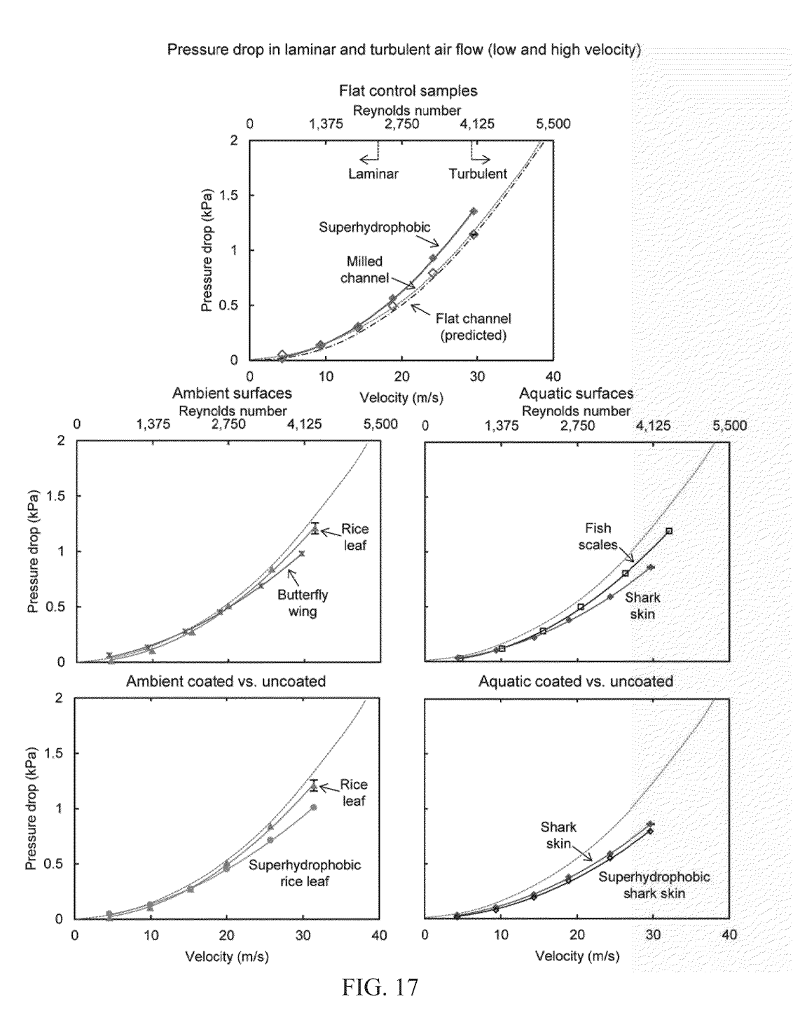

FIG. 17 shows results from the pressure drop experiments using air flow, comparing the flat control, replica ambient, replica aquatic, and replica coated versus uncoated samples. The results reflect laminar through high velocity turbulent air flow (0<Re<5500) with trend lines connected to the origin. Calculations used the values for mass density (ρ) of 1.2 kg m⁻³ and kinematic viscosity (ν) of 1.51×10⁻⁵ m² s⁻¹.

With air, the achievable velocity range was higher as compared to water or oil, and the higher Reynolds numbers show continued pressure drop reduction (until expected plateauing). When comparing fish scales and shark skin replica results of FIGS. 14B and 17, a smaller difference is observed in air versus water. The superhydrophobic coated rice and shark skin replica samples show an improved pressure drop reduction compared to the uncoated, but this is independent of the superhydrophobicity. The greatest benefit is shown in higher flow velocity conditions. When comparing the best performing samples, in water the superhydrophobic coated shark skin replica sample reduces pressure by 29% (Re=10,000) and in air reduces pressure by 27% (Re=4200). It is surmised that the coated shark skin benefits from the shark skin effect combined with surface roughness between riblets, which leads to lower drag. The nanostructured coating is deemed to improve surface roughness by filling in surface defects while maintaining the riblet microstructure.

### Results: Nondimensional Pressure Drop Model

Developing a nondimensional pressure drop expression allows one to estimate pressure drops for various fluids. This can be accomplished by combining Eqs. 2-4 and a dimensioness Reynolds number

$$Re = \frac{VD}{v} .$$

Solving for the nondimensional pressure drop as a function of Reynolds number yields:

$$\overline{Δ p} = \frac{Δ p}{G} = Re \\ with G = \frac{ρ {Lkv}^{2}}{2 {D}^{3}} \qquad ( 5 )$$

where G is the fluid property and channel dimension parameter. Eqn. 5 shows that pressure drop is directly proportional to velocity and nondimensional pressure drop is proportional to the Reynolds number. It allows one to effectively compare and study different fluids.

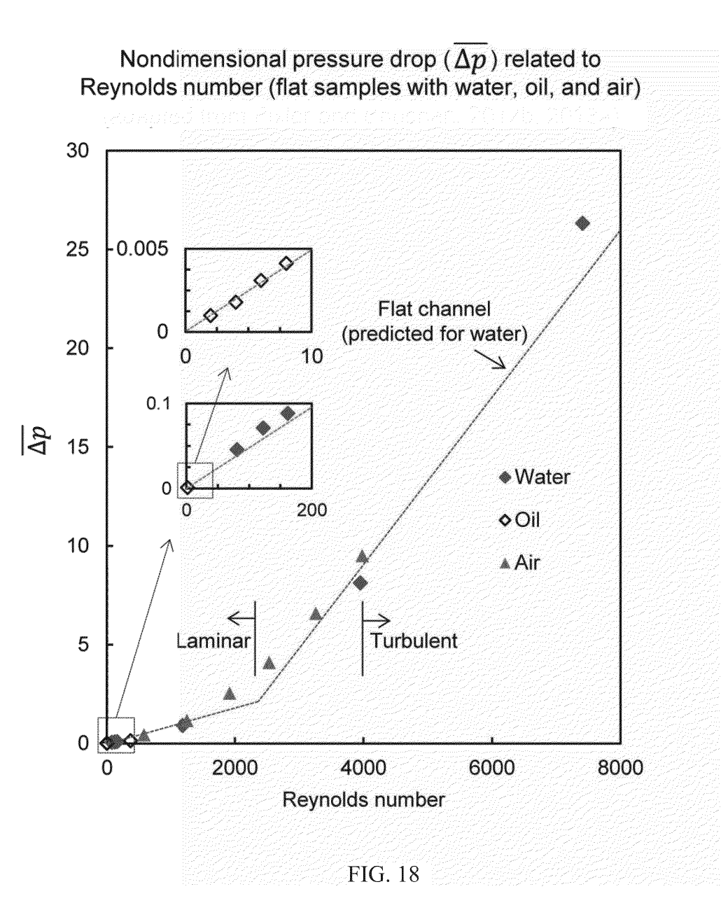

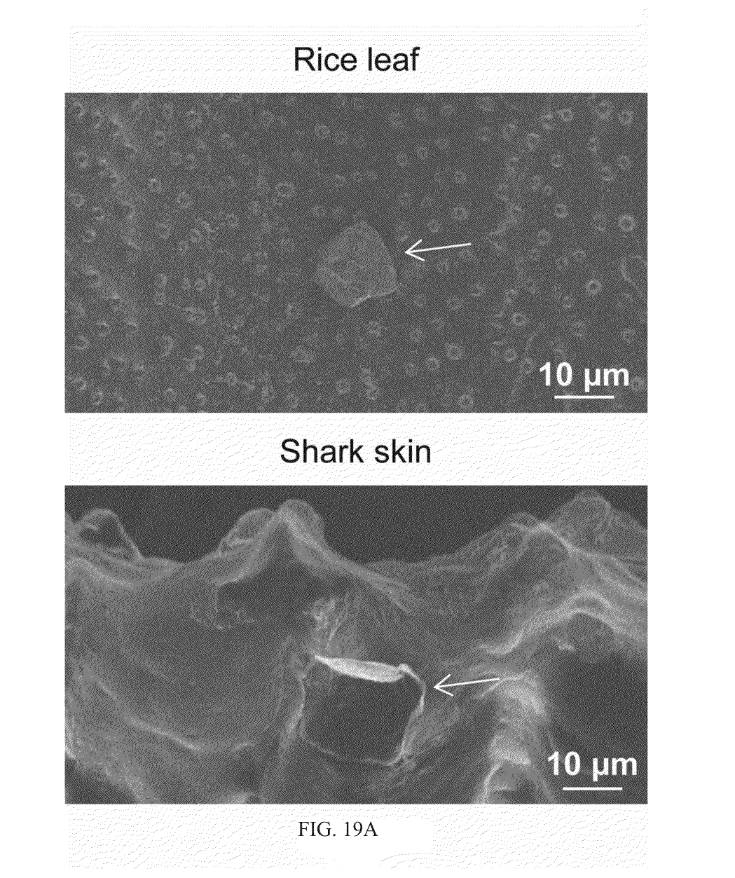

FIG. 18 shows nondimensional pressure drop values versus Reynolds numbers for a flat milled channel in water, oil, and air experiments. These fluids represent a wide range of densities and viscosities found in medical, marine, and industrial applications. As shown, the nondimensional pressure drop values follows similar calculated linear trend lines based on water flow, with a slope change between laminar and turbulent flow. In order to account for milled channel surface roughness, friction factor values estimated from the Moody chart were selected based on the roughness value of ε=0.0025 mm.

### Results: Self-Cleaning

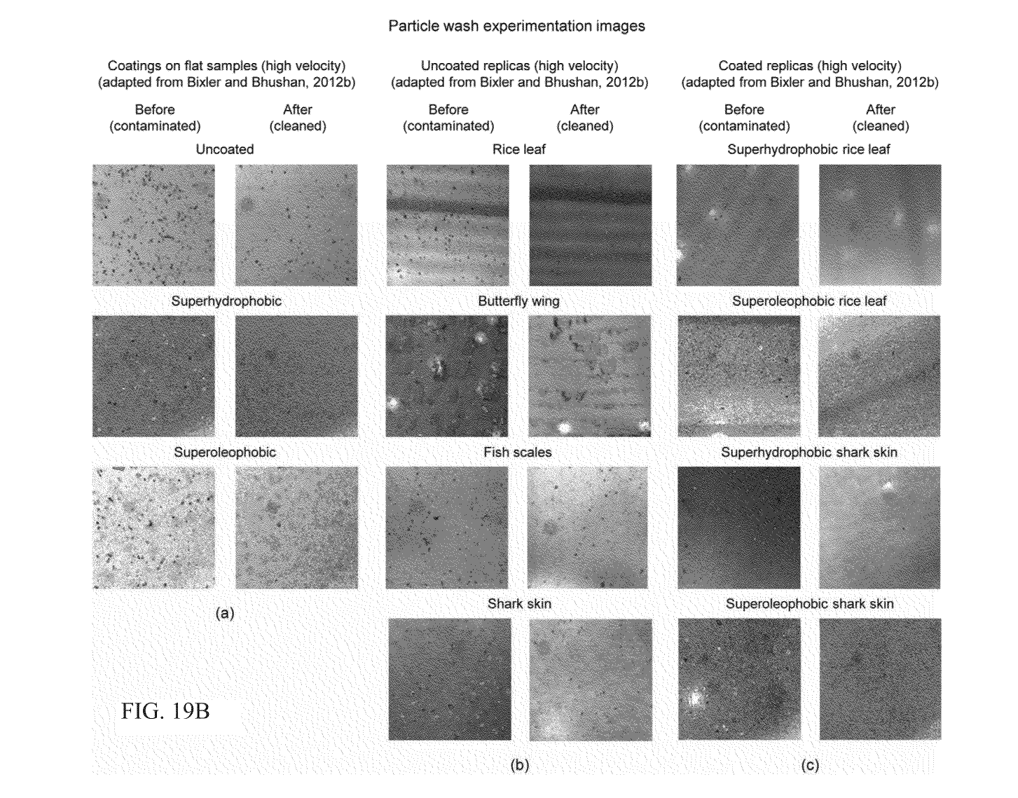

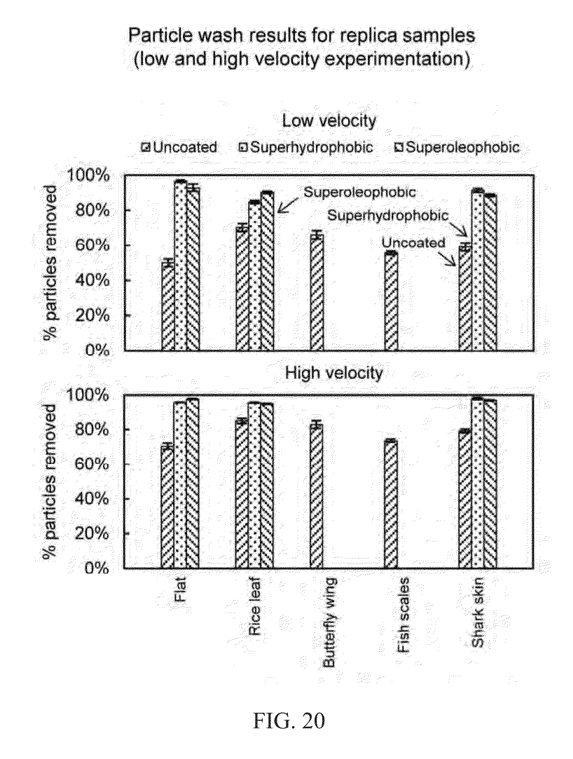

FIG. 19A shows SEM images of the superhydrophobic coated rice leaf and shark skin replica samples with SiC contaminant particles in accordance with the self-cleaning testing protocol described above. Several samples were subjected to wash experimentation to determine self-cleaning efficiency. FIG. 19B shows the before and after optical microscope images analyzing the changes from the high velocity experimentation for coated and uncoated flat samples, uncoated replica samples, and coated (both superhydrophobic coated and superoleophobic coated) replica samples. These images were used with imaging software to quantify the percentage of particles removed. Data in bar chart form are shown in FIG. 20 for both the low and high velocity droplet wash experiments. Each replica sample outperformed the flat control sample, indicating that the surface structures and coating under investigation each promote self-cleaning.

As expected, the superhydrophobic and superoleophobic coated samples outperformed the uncoated replicas and more particles were removed at higher versus lower velocities. The coatings amplify the self-cleaning abilities of the replicas, and it is surmised that the droplets are able to roll and collect the particles after impact. Furthermore, the coated samples exhibit the lower adhesion forces, suggesting that the particles are easier to remove versus uncoated. Self-cleaning is demonstrated with superhydrophobic coated rice leaf and shark skin replica samples at 95% and 98% contaminant removal, respectively, as compared to uncoated replica samples at 85% and 79%, respectively. The superoleophobic coated replica samples performed similarly. For comparison, the flat control sample showed a 70% contaminant removal.

Combining the lotus leaf and shark skin effects is evident with the coated rice leaf and shark skin replica samples, which improves the self-cleaning efficiency.

Results: Wettability with Water Droplets

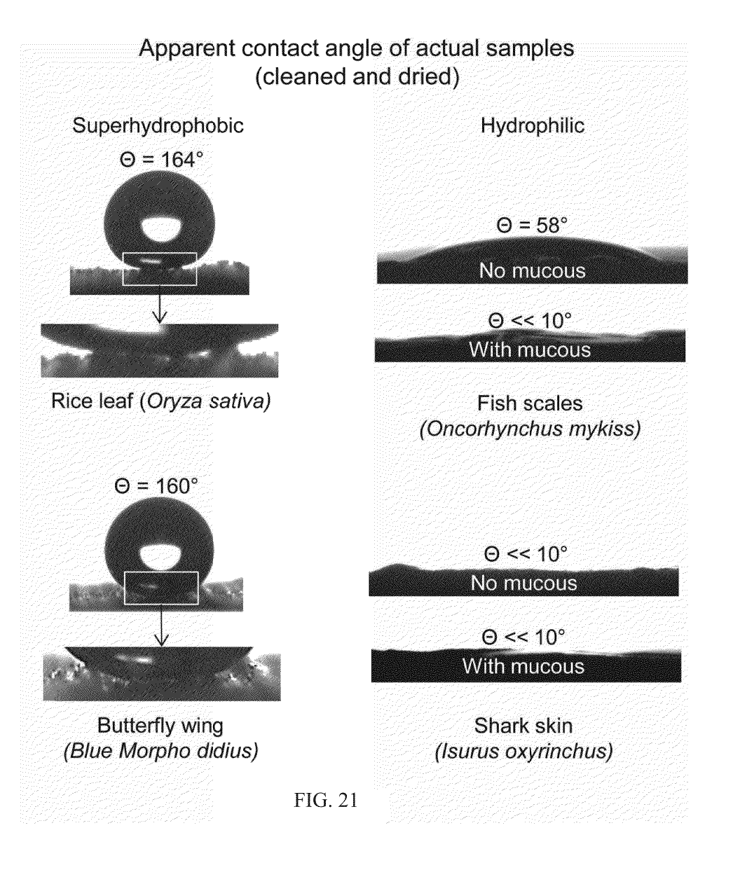

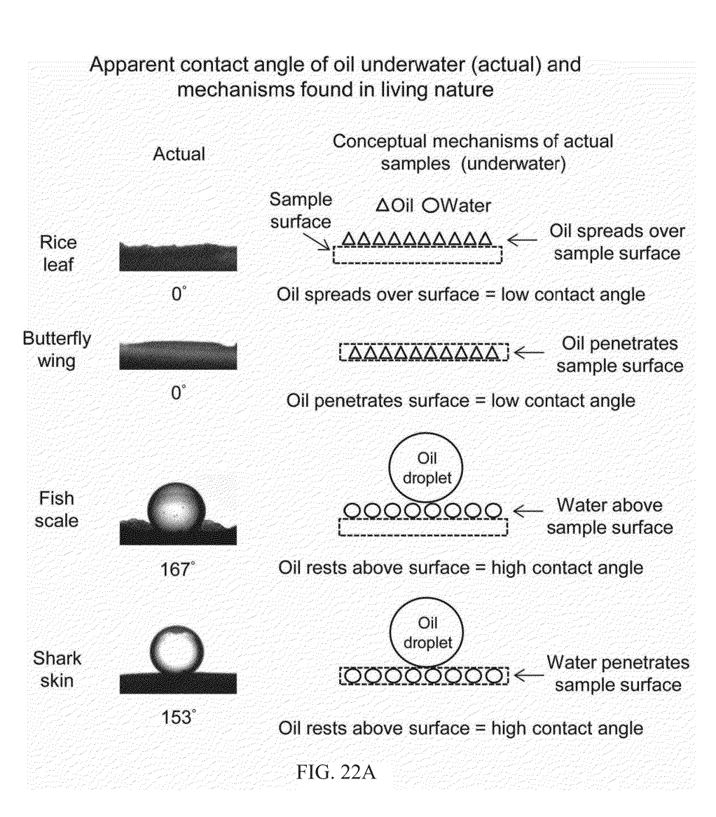

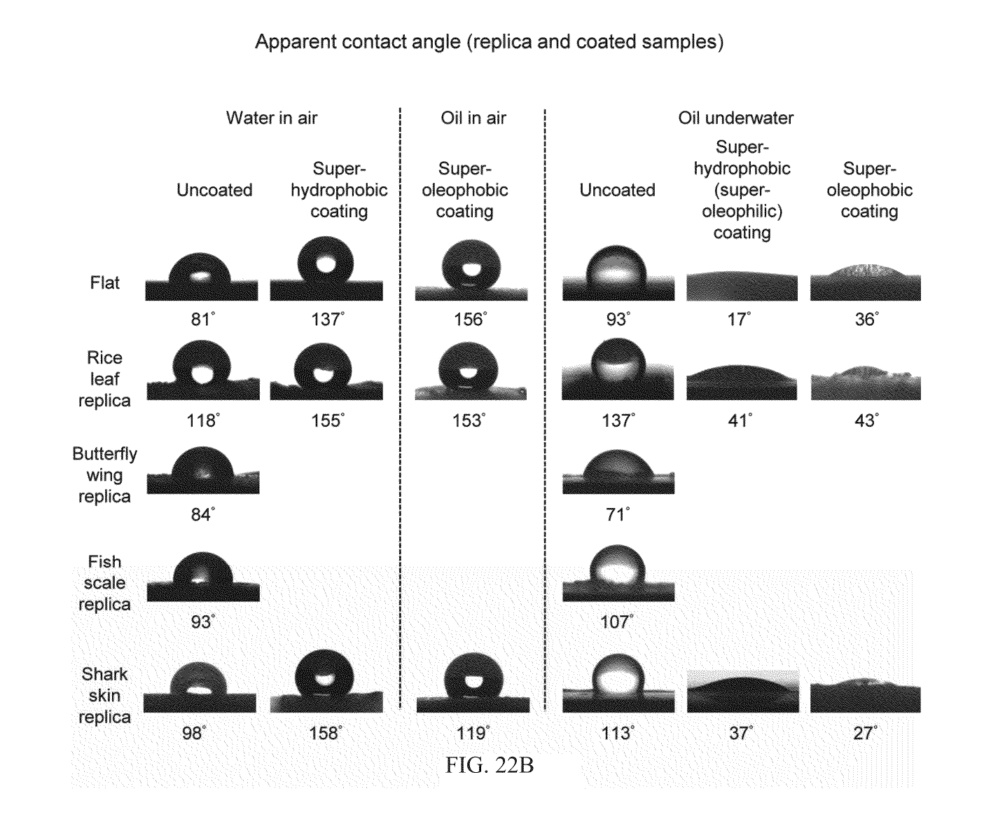

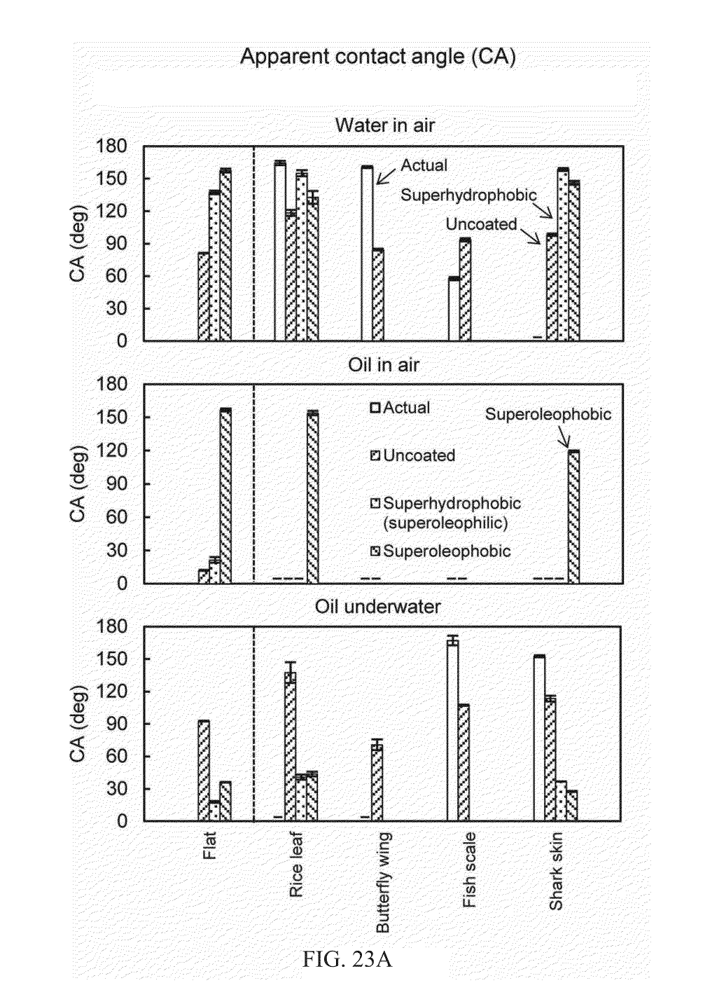

To understand the impact of water droplet apparent contact angle (θ) and thus wettability on drag and self-cleaning, a series of experiments were conducted with the actual, uncoated, and coated samples using water droplets as described above. Exemplary images and corresponding determined apparent contact angle (θ) of water droplets for several of the actual samples are summarized in FIG. 21; exemplary images and corresponding determined apparent contact angle (θ) for several of the uncoated replica samples are summarized in FIG. 22B. Measurements were taken in both the stream-wise and transverse flow directions, with the maximum values reported. For instance, rice leaf samples show a lower water contact angle when viewed in the stream-wise compared to the cross-stream direction, since the droplets are pinned between the longitudinal grooves. Samples with higher contact angles (rice leaf and butterfly wing) are believed to exhibit Cassie-Baxter wetting where air pockets are trapped beneath the droplet to create superhydrophobicity. Conversely, the fish scales sample shows a lower contact angle, presumably due to the Wenzel wetting when water penetrates between the individual asperities as shown in FIG. 21. As expected, the coated rice leaf and shark skin replica samples exhibit a higher contact angle than the uncoated samples, showing the effectiveness of the superhydrophobic coating.

When comparing pressure drop results with wettability, there is not a direct correlation, since the shark skin replica exhibits a lower contact angle but also higher pressure drop reduction. When combining the lotus effect with the shark skin effect, as demonstrated by coating the rice leaf and shark skin replicas, the new superhydrophobic surface provides benefit, which provides the greatest pressure drop reduction.

As a point of reference, contact angle and adhesion are important attributes for low drag and self-cleaning and can be estimated with Cassie-Baxter and Wenzel equations. Close examination of the solid-air-liquid interface reveals that the Wenzel regime does not contain an air pocket unlike the Cassie-Baxter regime. This difference, due at least in part to surface roughness, influences the surface wettability since the air pocket affords a larger contact angle θ and smaller CAH. Eqn (6) below describes the Wenzel equation where θ=contact angle, θ₀=contact angle of the droplet on the flat surface, R_{f}=roughness factor, A_{F}=flat projected area, and A_{SL}=solid-liquid surface area, whereas Eqn (7) below describes the Cassie-Baxter equation with f_{LA}=fractional flat liquid-air contact area.

Wenzel: cos θ=R_{f} cos θ₀ (6)

where R_{f}=A_{SF}/A_{F}.

Cassie-Baxter: cos θ=R_{f} cos θ₀−f_{LA}(R_{f} cos θ₀+1) (7)

Using optical profiler height map images (1.2×0.096 mm), the values of R_{f} and f_{LA} were obtained for several samples. The R_{f} value was estimated with optical profiler software by measuring the solid-liquid surface area and dividing by the flat projected area. The f_{LA} value was estimated with SPIP software by adjusting the asperity height threshold to remove the upper 25% of the peaks and measuring the remaining projected flat surface area. Using the so-obtained roughness factor and fractional liquid-air contact area measurements, the contact angles for the replica rice leaf, butterfly wing, fish scales, and shark skin were then estimated. Table 2 shows the values of R_{f} and f_{LA} from actual samples, along with a comparison to measured and predicted contact angles for each replica. Such a comparison aids in the understanding of Wenzel or Cassie-Baxter regimes for a water droplet on replica surfaces.

TABLE 2
Replica sample contact angle predictions

| | Actual | | | Replica | | | |
|---|---|---|---|---|---|---|---|
| | | Fractional | | CA | CA | | |
| | | liquid-air | | calculated using | calculated using | Measured | Measured |
| | Roughness | contact | Measured | Wenzel | Cassie-Baxter | CA | CA |
| Sample | factor (R_{f}) | area (f_{LA}) | CA | eqn (4) | eqn (5) | (uncoated) | (coated) |
| Rice leaf | 3.33 | 0.85 | 164^{b} | 59 | 141^{b} | 118 | 155^{a} |
| (Oryza sativa) | | | | | | | |
| Butterfly wing | 4.41 | 0.93 | 161^{b} | 48 | 152^{b} | 84 | n/a |
| (Blue Morpho | | | | | | | |
| didius) | | | | | | | |
| Fish scales | 1.61 | 0.33 | 58^{a} | 76^{a} | 99 | 94^{a} | n/a |
| (Oncorhynchus | | | | | | | |
| mykiss) | | | | | | | |
| Shark skin | 2.14 | 0.44 | n/a | 71^{a} | 105 | 98^{a} | 158 |
| (Isurus | | | | | | | |
| oxyrinchus) | | | | | | | |

^{a}Indicates the Wenzel regime.
^{b}Indicates the Cassie-Baxter regime.

The measured and predicted values correlate with the Cassie-Baxter for rice leaf and butterfly wing replicas; and Wenzel for fish scales and shark skin. This coincides with living nature, since the rice leaf and butterfly wing are found in the ambient environment (can exhibit air pockets), whereas fish scales and shark skin are designed for the marine environment (cannot exhibit air pockets).

Results: Wettability with Oil Droplets

Similar experiments were conducted with oil droplets in air and underwater. Contact angle measurements at the solid-air-oil interface are relevant for closed channel oil drag reduction, whereas measurements at the solid-water-oil interface are relevant for self-cleaning of underwater surfaces and vice-versa. Exemplary images, corresponding determined contact angle (θ) and conceptual mechanisms of oil droplets for several of the actual samples underwater are summarized in FIG. 22A; exemplary images and corresponding determined contact angle (θ) for oil droplets for various replica samples in air are summarized in FIG. 22B. As shown at the solid-water-oil interfaces, rice leaf and butterfly wing samples exhibited superoleophilicity whilst fish scale and shark skin samples exhibit superoleophobicity. For instance, with rice leaf the lower surface tension oil spreads over the higher surface tension hierarchical leaf With butterfly wing, the oil droplet penetrates into the wing upon contact, likely due to the fragile open lattice microstructure. With fish scales, it is surmised that a thin water layer forms between the oil droplet and the impenetrable scale surface to encourage superoleophobicity. With shark skin, water soaks into the skin and, combined with the impenetrable dermal denticle microstructures, produces superoleophobicity. Such superoleophobicity coupled with low adhesion provides self-cleaning, which is likely found with actual fish scales and shark skin in their native underwater environment.

The contact angles suggest oleophobic behavior except in the case of replica butterfly wing and superhydrophobic (superoleophilic) coated samples. The superhydrophobic coating is oleophilic at the solid-water-oil interface, and the superoleophobic coating is superoleophobic at the solid-air-oil interface. Oleophobicity is expected to be a function of surface tension. To begin, when a water droplet is placed on a surface in air, the solid-air-water interface forms the static contact angle of the droplet. The equation for the contact angle of a water droplet (Θ_{W}) in air is predicted by Young's equation:

$$cos {Θ}_{W} = \frac{{γ}_{SA} - {γ}_{SW}}{{γ}_{WA}} \qquad ( 8 )$$

where γ_{SA}, γ_{SW}, and γ_{WA} are the surface tensions of the solid-air, solid-water, and water-air interfaces, respectively. Eqn (8) predicts that hydrophilicity is possible when γ_{SA}>γ_{SW}.

However, the equation for the contact angle of an oil droplet (Θ₀) in air is predicted by Young's equation:

$$cos {Θ}_{O} = \frac{{γ}_{SA} - {γ}_{SO}}{{γ}_{OA}} \qquad ( 9 )$$

where γ_{SA}, γ_{SO}, and γ_{OA} are the surface tensions of the solid-air, solid-oil, and oil-air interfaces, respectively. Eqn (9) predicts that oleophilicity in air is possible when γ_{SA}>γ_{SO} where the surface energy of a solid surface must be higher than the surface tension of the oil.

Furthermore, the equation for the contact angle of an oil droplet (Θ_{OW}) in water is predicted by Young's equation:

$$cos {Θ}_{OW} = \frac{{γ}_{SW} - {γ}_{SO}}{{γ}_{OW}} \qquad ( 10 )$$

where γ_{SW}, γ_{SO}, and γ_{OW} are the surface tensions of the solid-water, solid-oil, and oil-water interfaces, respectively. Eqn (10) predicts that oleophobicity underwater (at the solid-water-oil interface) is possible when γ_{SO}>γ_{SW}. Further, it is believed that the surface tension of the solid-oil interface (γ_{SO}) is lower than the solid-air interface (γ_{SA}), therefore as predicted by Eqn 9 the result is oleophilicity.

### Results: Wettability Comparison of Water and Oil Droplets

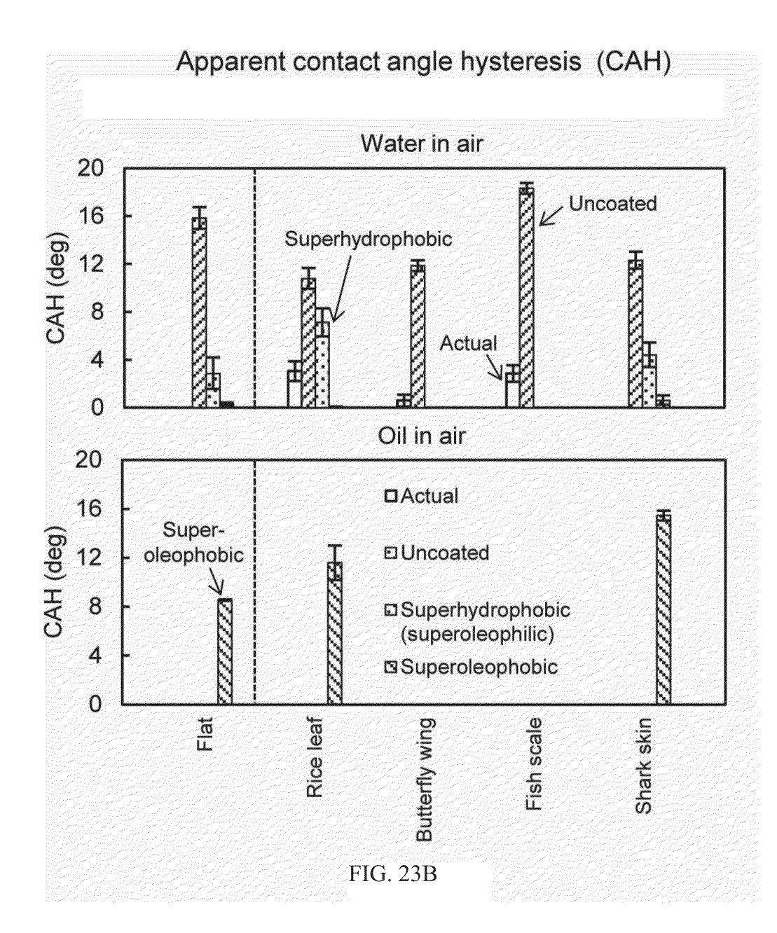

The results of the apparent contact angle (CA) of water droplets and oil droplets (in air and underwater) for the various samples described above are presented in tabulated form in FIG. 23A for purposes of comparison. A similar tabulated comparison of the results of the contact angle hysteresis (CAH) tests is presented in FIG. 23B. When high CA (>150°) is coupled with low CAH (<10°), it is expected that liquid droplets will easily be repelled. Shown are high CA and low CAH values found with droplets in actual rice leaf and butterfly wing samples and superhydrophobic coated replica samples. In addition, a similar trend was found with oil droplets on superoleophobic coated replica samples. Such values indicate low adhesion leading to low drag and self-cleaning.

When comparing the actual to replica samples there is a noticeable difference. In the case of rice leaf and butterfly wing samples, the contact angle difference between the actual and replica samples is significant. Conversely, the difference between the actual and replica fish scales and shark skin samples is lower. It is surmised that this is due to the different mechanisms at work and how the replicas differ from the actual samples. The greatest difference was found with oil droplets. For instance, the actual rice leaf is superoleophilic at the solid-water-oil interface whereas the replica rice leaf is oleophobic at the same interface. This is due to the lack of hierarchical structures on the replica that are present on the actual rice leaf. Once the nanostructured coating is applied to the replica rice leaf, the contact angle nears the contact angle of the actual rice leaf. Furthermore, the oil is unable to penetrate the replica butterfly wing as in the case of the actual sample, and a 71° (versus 0°) contact angle at the solid-water-oil interface was seen. Contact angles were lower for the replica fish scales and shark skin compared to the actual ones, presumably due to the absence of an oil-repellent water layer.

Results: Wettability comparison with laser etched riblets

Additional contact angle with oil droplet testing was performed on selected ones of the laser etched riblet samples. Contact angle measurements were taken at the solid-air-oil and for completeness also at the solid-water-oil interfaces, with images and results summarized. Contact angle measurements at the solid-air-oil interface are relevant for closed channel oil drag reduction, whereas measurements at the solid-water-oil interface are relevant for self-cleaning of underwater surfaces contacting oil, or vice versa. It is surmised that the high contact angle of oil droplets underwater encourages self-cleaning efficiency, which leads to lower drag in environments where contaminants may be present. Measurements were taken in both the streamwise and transverse flow directions, with the maximum values reported. For instance, rice leaf and continuous sawtooth riblet samples show a lower apparent contact angle when viewed in the streamwise compared to the transverse direction, since the droplets are pinned between the longitudinal grooves.

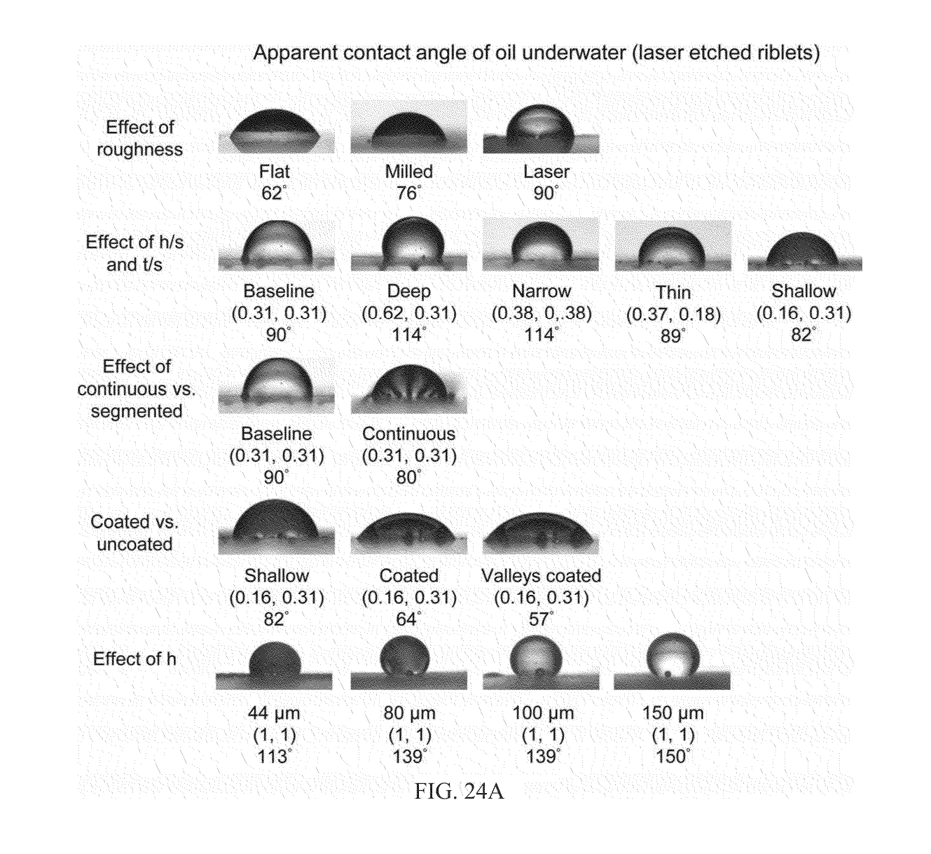

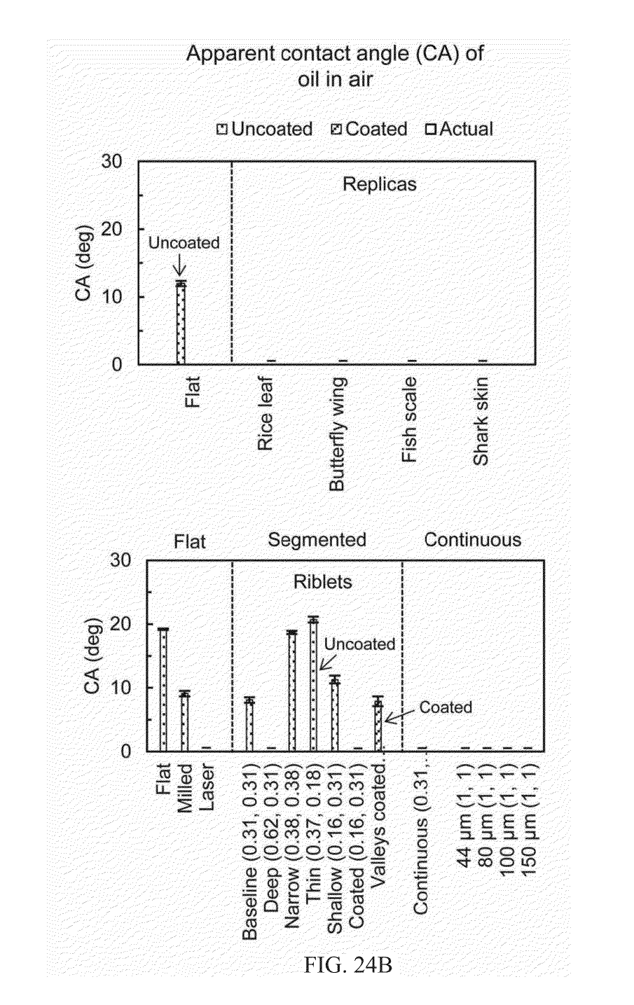

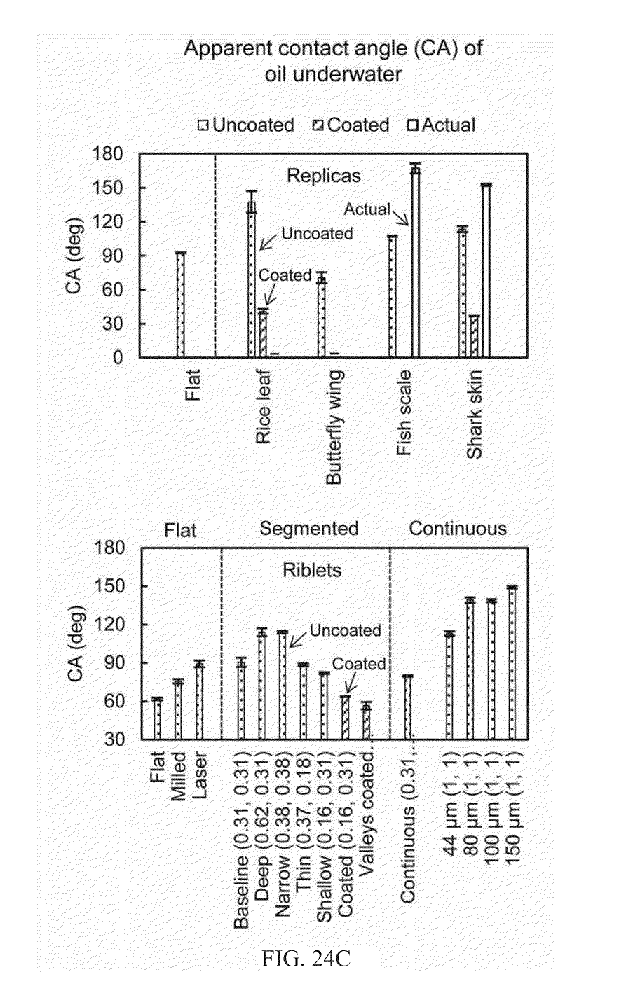

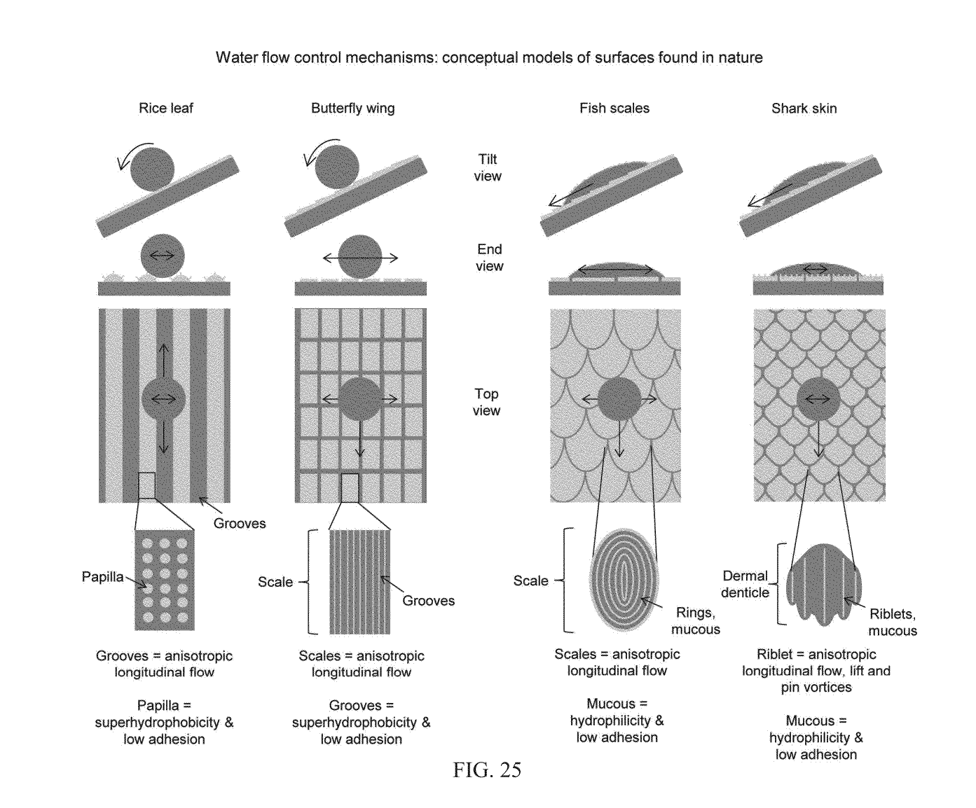

FIG. 24A illustrates the laser etched riblet and sawtooth samples and contact angles at the solid-water-oil interface. It was determined that the contact angle increases with nanoscale roughness and riblets that are deeper, segmented, and uncoated. It was further determined that the contact angles were highest with the 150 mm (1, 1) and lowest with the Valleys coated (0.16, 0.31) laser etched riblet samples, at 150° and 57° respectively.

A summary of apparent contact angle data for several actual, replica, coated replica and laser etched riblet sample at both the solid-air-oil (FIG. 24B) and solid-water-oil (FIG. 24C) interfaces was tabulated. As shown, each sample in the solid-air-oil interface is superoleophilic except the laser etched sample, which is oleophilic. The nanostructured coating makes the laser etched samples superoleophilic and maintains superoleophilicity in replica samples. It is surmised that the surface tension of the solid-oil (γ_{SO}) interface is lower than that of the solid-air (γ_{SA}) interface, therefore as predicted by Eqn (9) the result is oleophilicity.

### Results: Contact Angle and Drag

When comparing the drag results with wettability, there does not appear to be a direct correlation, although high CA coupled with low CAH provides superior self-cleaning. For instance, it was determined that drag reduction is possible with both sup erhydrophobic/oleophobic as well as superoleophilic surfaces, and superhydrophobic/oleophobic surfaces provide superior self-cleaning. Drag reduction mechanisms differ for the various fluids under investigation with considerations given to liquid repellency, low adhesion, and anisotropic flow. In the case of water flow, superhydrophobicity and low adhesion provide the greater drag reduction. However in oil flow, the superoleophilic surfaces provide drag reduction with the thin film effect whereas superoleophobic surfaces perform similarly due to liquid repellency and low adhesion. Therefore, lower drag is achieved when appropriate wettability is coupled with the appropriate surface morphology, which can promote anisotropic flow, liquid repellency, low adhesion, control of turbulent vortices, and/or produce the thin oil film.

### Model for Low Drag and Self-Cleaning

Low drag and self-cleaning are desirable properties, and it is important to understand the mechanisms at work to replicate living nature. Conceptual modeling of each sample is shown in FIG. 25, illustrating simplified surface morphologies and water droplet behavior. As shown, the self-cleaning rice leaf and butterfly wings easily repel water, whereas the fish scales and shark skin essentially attract water. Furthermore, the longitudinal grooves and scales as found on the rice leaf, butterfly wing, fish scale, and shark skin efficiently direct water, which is believed to lower drag. The water droplets sit above the hierarchical surface structures of the rice leaf and butterfly wing, whereas they penetrate the surface structures of fish scales and shark skin. By staying above, the droplet can more easily roll and collect contaminants to improve self-cleaning efficiency. Mucous found on fish scale and shark skin is believed to act as a lubricant, and further reduce drag with the lower skin friction. This also provides antifouling benefits since the water next to the fish scales and shark skin moves quickly and prevents microorganisms from attaching.

### CONCLUSIONS

Using the experimental and modeling information, the novel bioinspired self-cleaning low-drag surfaces of the present disclosure are highly viable by combining shark skin and lotus leaf effects into a rice leaf and butterfly wing model effect. The rice leaf surface was surprisingly found to be desirable due to its self-cleaning and low drag properties, as well as relatively simple two-dimensional cylindrical pillar geometry. The rice leaf and butterfly wing effect is successfully designed into a fluid flow interface surface using a uniform micropattern of optionally superhydrophobic low adhesion cylindrical pillars arranged in longitudinal rows. This surface structure will work well with water, oil, and air flow in laminar and turbulent regimes.

For the first time it has been surprisingly discovered that rice leaves and butterfly wings combine the desirable shark skin (anisotropic flow leading to low drag) and lotus (superhydrophobic and self-cleaning) effects, creating the rice leaf and butterfly wing effect. These unique surfaces exhibit anisotropic flow, water repellency, self-cleaning, and low adhesion properties, which is believed to promote low drag, self-cleaning, and anti-fouling. It is surmised that the sinusoidal grooves in rice leaf or the aligned shingle-like scales in butterfly wings provide anisotropic flow leading to low drag. Hierarchical structures consisting of micropapillae superimposed by waxy nanobumps in rice leaves or microgrooves on top of shingle like scale structures in butterfly wings provide superhydrophobicity and low adhesion.

It has surprisingly been found that the lotus effect nanostructured coating applied to the rice leaf and shark skin replicas produced the rice leaf and butterfly wing effect, where the coated rice leaf replica closely mimics the actual rice leaf. It has surprisingly further been found that rice leaf and butterfly wing effect samples show reduced drag, increased contact angle, and improved self-cleaning efficiency. The greatest drag reduction benefit is demonstrated in turbulent flow, where the maximum pressure drop reduction occurs with Superhydrophobic coated rice leaf and shark skin replicas at 26% and 29%; and uncoated at 17% and 19%, respectively. A 10% pressure drop reduction using both the superoleophilic and superoleophobic rice leaf replica samples in laminar oil flow. The greatest self-cleaning is shown with the lotus effect coated samples, where the maximum contaminant removal occurs with superhydrophobic coated rice leaf and shark skin replicas at 95% and 98%; and uncoated at 85% and 79%, respectively.

A correlation was found with the laser etched riblet samples. It was observed that the coating seems to enhance drag reduction at the low velocity with riblets but provides negligible benefit at the high velocity. At low velocity, the Coated and Valleys laser etched riblet coated samples show a noticeable drag reduction compared to their uncoated counterpart. Furthermore, it was found that the coating can increase drag, as in the case of the coated shark skin replica, where a slight increase in drag was observed. Comparing coated to uncoated, drag reduction improvement by coating the shallow laser etched riblet sample (4% reduction for coated vs. 1% increase for uncoated) was observed. From this, it is surmised that lower drag is achieved when superoleophilicity is coupled with the appropriate surface morphology to produce what is likely the thin oil film at the surface. Drag was also reduced using the butterfly wing replica and the laser etched riblet Narrow (0.38, 0.38) samples, with pressure drop reductions of 6% and 9%, respectively. The remaining samples—fish scales, shark skin and various laser etched riblet samples—either exhibited negligible differences or drag increase compared to the flat control. It is surmised that such surfaces do not form the thin oil film and thus the increased wetted surface area translates into higher friction/drag. Since the oil flow is laminar in each experiment, the shark skin effect was not present due to the lack of turbulent vortices.

In addition to low drag, it is surmised that an increased flow rate at the surface encourages self-cleaning by reducing the opportunity for contaminants to settle. Incidentally, it was determined that actual fish scale and shark skin samples are superoleophobic at the solid-water-oil interface. It is surmised that bioinspired surfaces based on actual fish scale and shark skin can promote self-cleaning in applications where oil is contaminating water, or vice versa.

Developing a new low drag and self-cleaning surface model inspired by rice leaves is achieved. Drag can be reduced by appropriate micro/nanostructures that provide a thin oil film at the solid-liquid interface. Such bioinspired surfaces can be created using a uniform micropattern of cylindrical pillars arranged in a uniformly spaced pattern having superoleophilicity. The spacing of the rice leaf-inspired micropillars is, in some embodiments, slight smaller than many common microorganisms, which prevents microorganism attachment to the surface and thus colonization leading to a biofilm. This investigation has successfully developed and characterized new bioinspired low oil drag surfaces, confirming that the new rice leaf replica and rice leaf-like hierarchical textured surfaces of the present disclosure are highly viable for various medical, marine, and industrial applications.

Although the present disclosure has been described with reference to preferred embodiments, workers skilled in the art will recognize that changes can be made in form and detail without departing from the spirit and scope of the present disclosure.

What is claimed is:

1. A fluid conveying apparatus comprising:
a wall structure forming a channel for conveying fluid, the channel being bounded by an interior face of the wall structure; and
a rice leaf-like textured surface formed on the interior face, the textured surface including:
a plurality of micropillars projecting from the interior face and arranged in a geometry akin to rice leaf micropapillae.

2. The fluid conveying apparatus of claim 1, wherein the plurality of micropillars are arranged to define a plurality of longitudinal grooves having a transverse sinusoidal pattern.

3. The fluid conveying apparatus of claim 1, wherein each of the plurality of micropillars has a diameter in the range of 2-4 μm.

4. The fluid conveying apparatus of claim 1, wherein each of the plurality of micropillars has a height in the range of 2-4 μm.

5. The fluid conveying apparatus of claim 1, wherein the plurality of micropillars are arranged in a micropattern defining a plurality of rows of the micropillars.

6. The fluid conveying apparatus of claim 5, wherein the micropillars of immediately adjacent rows are transversely aligned.

7. The fluid conveying apparatus of claim 5, wherein the micropillars of immediately adjacent rows are transversely off-set.

8. The fluid conveying apparatus of claim 5, wherein each of the micropillars has a nominal diameter, and further wherein a center-to-center transverse pitch between immediately adjacent rows is less than 3 times the nominal diameter.

9. The fluid conveying apparatus of claim 5, wherein a center-to-center transverse pitch distance between immediately adjacent rows is in the range of 5-10 μm.

10. The fluid conveying apparatus of claim 5, wherein the micropattern further defines a plurality of sets of micropillars, wherein each of the sets includes a plurality of the rows, and further wherein a center-to-center pitch distance between immediately adjacent rows of each of the sets is less than a lateral distance between immediately adjacent sets.

11. The fluid conveying apparatus of claim 10, wherein each of the sets includes 3 rows.

12. The fluid conveying apparatus of claim 9, wherein the plurality of sets includes first and second sets, and further wherein the lateral distance between the first and second sets is defined between a last row of the first set and a first row of the second set, the last row being immediately adjacent the first row, and further wherein the lateral distance is less than 3 times the center-to-center pitch distance.

13. The fluid conveying apparatus of claim 9, wherein the plurality of sets includes first and second sets, and further wherein the lateral distance between the first and second sets is defined between a last row of the first set and a first row of the second set, the last row being immediately adjacent the first row, and further wherein the lateral distance is in the range of 4-12 μm.

14. The fluid conveying apparatus of claim 5, wherein the micropattern further includes a plurality of microribs, respective ones of the microribs being disposed between adjacent ones of the rows of micropillars.

15. The fluid conveying apparatus of claim 14, wherein a height of the microribs is greater than a height of the micropillars.

16. The fluid conveying apparatus of claim 1, wherein the textured surface further includes a nanostructured coating applied to each of the micropillars.

17. The fluid conveying apparatus of claim 16, wherein the nanostructured coating renders the micropillars superhydrophobic.

18. The fluid conveying apparatus of claim 16, wherein the nanostructured coating is configured to mimic waxy nanobumps of a rice leaf.

19. The fluid conveying apparatus of claim 16, wherein the nanostructured coating includes hydrophobisized silica nanoparticles.

20. The fluid conveying apparatus of claim 1, further comprising an adhesive-backed sheet applied to the interior face and forming the textured surface.

21. The fluid conveying apparatus of claim 1, wherein the textured surface is integrally formed by the wall structure as a homogeneous body.

22. The fluid conveying apparatus of claim 1, wherein the channel defines a cross-sectional shape selected from the group consisting of a circle and parallelogram.

23. The fluid conveying apparatus of claim 1, wherein the apparatus is configured to convey a fluid selected from the group consisting of oil and water.

24. A method of manufacturing an apparatus for conveying fluid, the method comprising:
forming a textured surface on an interior face of a wall structure, the interior face bounding a channel in the wall structure, wherein the textured surface is rice leaf-like and includes a plurality of micropillars projecting from the interior face and arranged in a geometry akin to rice leaf micropapillae;
wherein fluid flowing through the channel is subjected to minimal drag along the textured surface.

25. The method of claim 24, wherein the step of forming the textured surface includes:
providing an adhesive-backed sheet forming the textured surface; and
applying the sheet to the interior face.

26. The method of claim 24, wherein the step of forming the textured surface includes:
molding the outer wall to include the textured surface.
